(19) United States
(12) Patent Application Publication
(10) Pub. No.: US 2022/0080444 A1
(43) Pub. Date: Mar. 17, 2022

(54) COATING DEVICE

(71) Applicant: ROBOPRINT CO.,LTD, Daegu (KR)

(72) Inventors: Jung Kyu PARK, Daegu (KR); Jae Jin LEE, Daegu (KR); Min Su KIM, Gyeongju-si (KR)

(73) Assignee: ROBOPRINT CO.,LTD, Daegu (KR)

(21) Appl. No.: 17/418,716

(22) PCT Filed: Dec. 23, 2019
(86) PCT No.: PCT/KR2019/018277

§ 371 Date: Jun. 25, 2021

(30) Foreign Application Priority Data
Dec. 27, 2018 (KR) 10-2018-0170198
Dec. 27, 2018 (KR) 10-2018-0170199
Dec. 27, 2018 (KR) 10-2018-0170200
Dec. 27, 2018 (KR) 10-2018-0170201
Dec. 27, 2018 (KR) 10-2018-0170202

(51) Int. Cl. B05B 13/04; B05B 15/68; B05B 12/32; B05C 1/08

(52) U.S. Cl. CPC B05B 13/0415; B05C 1/0813; B05B 12/32; B05B 15/68

(57) ABSTRACT

A coating device according to one embodiment of the present invention is a device for coating, with a paint, a target surface which is at least a part of a wall surface of a building, and comprises: a first movement part that can move in the vertical direction in accordance with a change in the length of a wire by driving of a winch drum; and a spraying part that can move in the left or right direction along the first movement part, and directly sprays the paint on the target surface or sprays the paint on a coating roller that rotates in contact with the target surface, such that a range from a predetermined left line to a predetermined right line of the target surface with reference to the left and right directions can be coated with the paint.

### TECHNICAL FIELD

The present invention relates to an application apparatus, and more particularly, to an application apparatus configured to apply paint to at least a part of a wall surface of a structure.

### BACKGROUND ART

In the case of applying paint to a wall surface of a structure, printing a variety of images such as a picture, text, symbol, logo, and the like on a wall surface using paint in order to decorate the structure, or coating a wall surface of a structure with a coating agent, conventionally, a platform is suspended from a rooftop of a structure by wires to be vertically movable using a swing stage or the like and a worker directly performs applying, imaging, or coating while getting on the platform or a worker performs the above work while descending on the wires fixed to the rooftop.

However, since it is necessary for a worker to directly work at a high position on a structure in the above work method, the worker is always exposed to a risk of falling and a danger of accident further increases when the wind is slightly strong.

Also, since the worker performs applying or imaging at a high place, the worker is not free to move such that the applying or imaging is slower and a working period increases.

Also, in addition of the above dangers of industrial accidents, due to the characteristic of the work being manually performed by a worker, labor costs have been unnecessarily added and have caused an increase in construction costs.

Due to the above reason, apparatuses configured to automatically apply paint to an outer wall of a structure or to automatically apply or print a variety of images such as a picture, text, symbol, logo, and the like thereto or thereon in order to decorate the structure have been developed. However, it is impossible to prevent the paint from scattering while conventional applying or printing apparatuses are operating.

Also, conventional applying or printing apparatuses have a limitation in which consumers are not completely satisfied with application performance.

### DISCLOSURE

### Technical Problem

The present invention is directed to providing an application apparatus configured to improve an application speed and applying qualities regardless of a condition of a wall surface of a structure while preventing the paint being sprayed from scattering and improving and improving application performance beyond a structural limitation of the apparatus.

### Technical Solution

One aspect of the present invention provides an application apparatus which is an apparatus configured to apply paint to a target surface that is at least a part of a wall surface of a structure and includes a first moving portion configured to be movable in a vertical direction according to a change in a length of a wire caused by driving of a winch drum and a spraying portion configured to be movable along the first moving portion in a leftward direction or a rightward direction and to directly spray paint onto the target surface or spray paint onto an application roller rolling in contact with the target surface so as to apply the paint to the target surface in a range from a predetermined left line to a predetermined right line in the lateral direction. Here, when the paint is sprayed while the first moving portion is located at a first position on the basis of a vertical direction, the spraying portion sprays the paint in a range from a predetermined left point corresponding to the first position to a predetermined right point corresponding to the first position while a uniform linear distance from the first moving portion according to a vertical direction is maintained. The first moving portion is movable in the vertical direction to allow the spraying portion to be movable from an uppermost line to a lowermost line of the target surface. Also, the first moving portion is moved only in any one of an upward direction and a lower direction so as to allow the paint sprayed by the spraying portion to be applied to a certain area within the range from the predetermined left line to the predetermined right line.

The spraying portion may move in at least one direction of the leftward direction and the rightward direction and may spray the paint while the first moving portion is located at the first position.

When the target surface is divided into a plurality of regions along the lateral direction on the basis of a moving range of the spraying portion in the lateral direction, the predetermined left line and the predetermined right line may be an outermost left line and an outermost right line for a particular region, respectively.

The first moving portion may extend along the lateral direction of the target surface and may cover a range of the target surface in the lateral direction.

The first moving portion may include a support portion provided to extend at a certain length along the lateral direction of the target surface and configured to support movement of the spraying portion and a rotating portion configured to rotate in contact with the target surface so as to move in the lateral direction while being spaced apart from the target surface.

The application apparatus may further include a second moving portion mounted on the first moving portion and configured to support the spraying portion to allow the spraying portion to be movable along the first moving portion.

The second moving portion may define a distance from the predetermined left point to the predetermined right point.

When the application of the paint to the certain area through movement of the first moving portion and spraying of the paint by the spraying portion is completed, the second moving portion may be moved along the first moving portion to allow the paint sprayed by the spraying portion to be applied to another certain region within a range from another predetermined left line to another predetermined right line.

The application apparatus may further include a first scattering prevention portion and a second scattering prevention portion which are disposed in front of the spraying portion and configured to prevent the paint sprayed through the spraying portion from scattering. Here, the first scattering prevention portion may prevent the paint sprayed through the spraying portion from scattering by absorbing the paint. Also, the second scattering prevention portion may be disposed outside the first scattering prevention portion and may expand a range of preventing the paint from scattering.

The spraying portion may move in at least one direction of the leftward direction and rightward direction and may spray the paint while the first moving portion is located at the first position. The first scattering prevention portion may include a 1-1 scattering prevention portion and a 1-2 scattering prevention portion which are formed of cylindrical sponges and disposed on an upper front side and a lower front side of the spraying portion, respectively. The second moving portion may include a lateral support frame configured to support movement of the spraying portion in the lateral direction and to define a moving range thereof in the lateral direction and a mounting frame on which the 1-1 scattering prevention portion and the 1-2 scattering prevention portion are rotatably mounted due to contact with the target surface. The mounting frame may include an upper cover frame and a lower cover frame which are configured to cover an upper side and a lower side of the spraying portion, respectively. The 1-1 scattering prevention portion may be disposed to be spaced apart from the upper cover frame so as to prevent interference with the upper cover frame when being rotated on the mounting frame due to the contact with the target surface. Also, the 1-2 scattering prevention portion may be disposed to be spaced apart from the lower cover frame so as to prevent interference with the lower cover frame when being rotated on the mounting frame due to the contact with the target surface.

The second scattering prevention portion may include a 2-1 scattering prevention portion disposed above the 1-1 scattering prevention portion and configured to spray high-pressure air so as to prevent the paint sprayed from the spraying portion from scattering through a space between the 1-1 scattering prevention portion and the upper cover frame.

The second scattering prevention portion may include a 2-2 scattering prevention portion disposed below the 1-2 scattering prevention portion and configured to spray high-pressure air so as to prevent the paint sprayed from the spraying portion from scattering through a space between the 1-2 scattering prevention portion and the lower cover frame.

The first scattering prevention portion may be formed along the lateral direction to correspond to the moving range of the spraying portion in the lateral direction on the lateral support frame, and a plurality of such second scattering prevention portions may be arranged spaced apart along the lateral direction within the moving range of the spraying portion in the lateral direction.

The first scattering prevention portion may be disposed along the lateral direction to correspond to the moving range of the spraying portion in the lateral direction on the lateral support frame, and the second scattering prevention portion may be disposed to be movable in the lateral direction in connection with the movement of the spraying portion in the lateral direction.

Another aspect of the present invention provides an application apparatus which is an apparatus configured to apply paint to a target surface that is at least a part of a wall surface of a structure and includes a first moving portion configured to be movable in a vertical direction from an uppermost line to a lowermost line of a target surface of the wall surface which needs an application of paint according to a change in a length of a wire caused by driving of a winch drum and formed to extend along a lateral direction of the target surface so as to cover a lateral range of the target surface and a spraying portion configured to be movable along the first moving portion in a leftward direction or a rightward direction and to directly spray paint onto the target surface or spray paint onto an application roller rolling in contact with the target surface so as to apply the paint to the target surface in a range of between a predetermined left line and a predetermined right line on the basis of a lateral direction. Here, the spraying portion implements application of the paint in the vertical direction due to movement of the first moving portion in the vertical direction.

### Advantageous Effects

According to the present invention, an application apparatus can improve an application speed and application quality regardless of a condition of a wall surface of a structure so as to implement effects of reducing a working period and reducing construction costs according thereto.

Also, paint being spray can be prevented from scattering, and application performance can be improved beyond a structural limitation of the apparatus.

### DESCRIPTION OF DRAWINGS

FIG. 1 is a schematic perspective view of an application apparatus according to one embodiment of the present invention and illustrating a state in which the application apparatus according to one embodiment of the present invention is located on a wall surface of a structure.

FIGS. 2 to 7 are views illustrating a situation in which paint is applied to the wall surface of the structure by the application apparatus according to one embodiment of the present invention.

FIG. 8 is a schematic perspective view illustrating a second moving portion provided in the application apparatus according to one embodiment of the present invention.

FIG. 9 is a schematic cross-sectional view taken along line AA of FIG. 8.

FIG. 10 is a schematic cross-sectional view taken along line AA of FIG. 8 and illustrating a reapplying function of the application apparatus according to one embodiment of the present invention.

FIG. 11 is a schematic perspective view illustrating an application apparatus according to another embodiment of the present invention.

FIG. 12 is a schematic perspective view illustrating a state in which the application apparatus according to another embodiment of the present invention is located on a wall surface of a structure.

FIG. 13 is a schematic perspective view illustrating a process in which the application apparatus according to one embodiment of the present invention applies paint to an inner wall of a structure.

FIG. 14 is a view illustrating a first control method of a spraying portion provided in an application apparatus according to the present invention.

FIG. 15 is a view illustrating a second control method of the spraying portion provided in an application apparatus according to the present invention.

FIG. 16 is a view illustrating a third control method of the spraying portion provided in an application apparatus according to the present invention.

### BEST MODE FOR INVENTION

An application apparatus according to one embodiment of the present invention is an apparatus configured to apply paint to a target surface that is at least a part of a wall surface of a structure and includes a first moving portion configured to be movable in a vertical direction according to a change in a length of a wire caused by driving of a winch drum and a spraying portion configured to be movable along the first moving portion in a leftward direction or a rightward direction and to directly spray paint onto the target surface or spray paint onto an application roller rolling in contact with the target surface so as to apply the paint to the target surface in a range from a predetermined left line to a predetermined right line in the lateral direction. Here, when the paint is sprayed while the first moving portion is located at a first position on the basis of a vertical direction, the spraying portion sprays the paint in a range from a predetermined left point corresponding to the first position to a predetermined right point corresponding to the first position while a uniform linear distance from the first moving portion according to a vertical direction is maintained. The first moving portion is movable in the vertical direction to allow the spraying portion to be movable from an uppermost line to a lowermost line of the target surface. Also, the first moving portion is moved only in any one of an upward direction and a lower direction so as to allow the paint sprayed by the spraying portion to be applied to a certain area within the range from the predetermined left line to the predetermined right line.

### Modes of the Invention

Hereinafter, particular embodiments of the present invention will be described in detail with reference to the drawings. However, the concept of the present invention is not limited to the disclosed embodiments, and one of ordinary skill in the art to which the present invention pertains may easily implement retrogressive inventions or other embodiments included in the conceptual scope of the present invention through addition, change, deletion, and the like of another component without departing from the conceptual scope, which should be included in the conceptual scope of the present invention.

Also, in the drawings for the embodiments, elements having the same function within the same conceptual scope will be referred to with the same reference numerals.

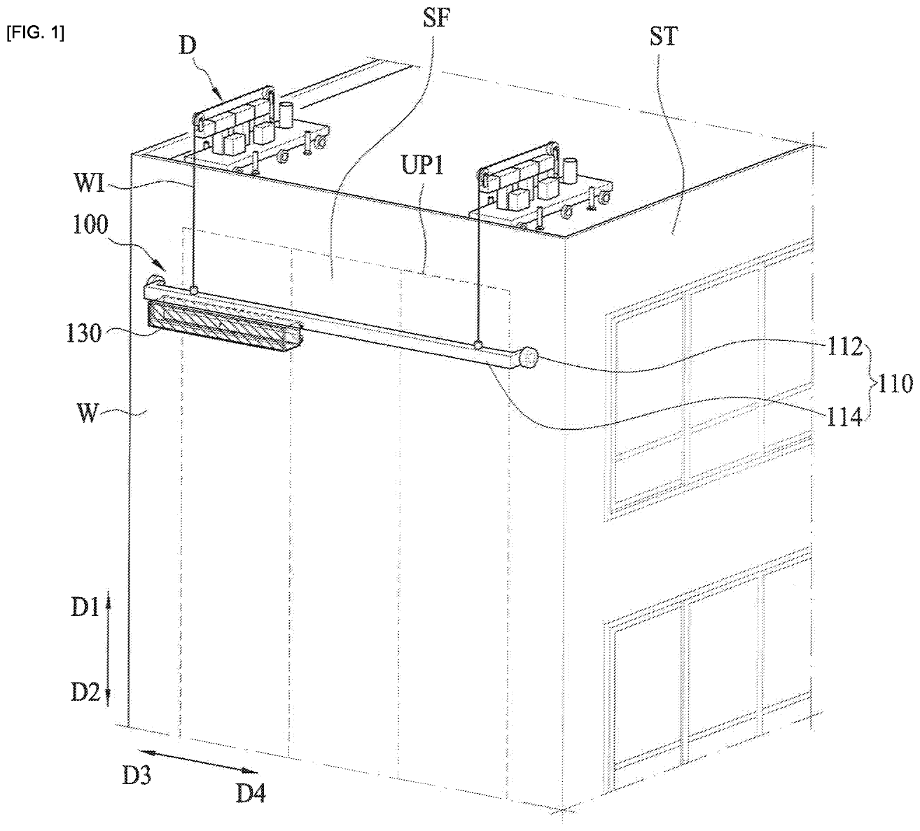

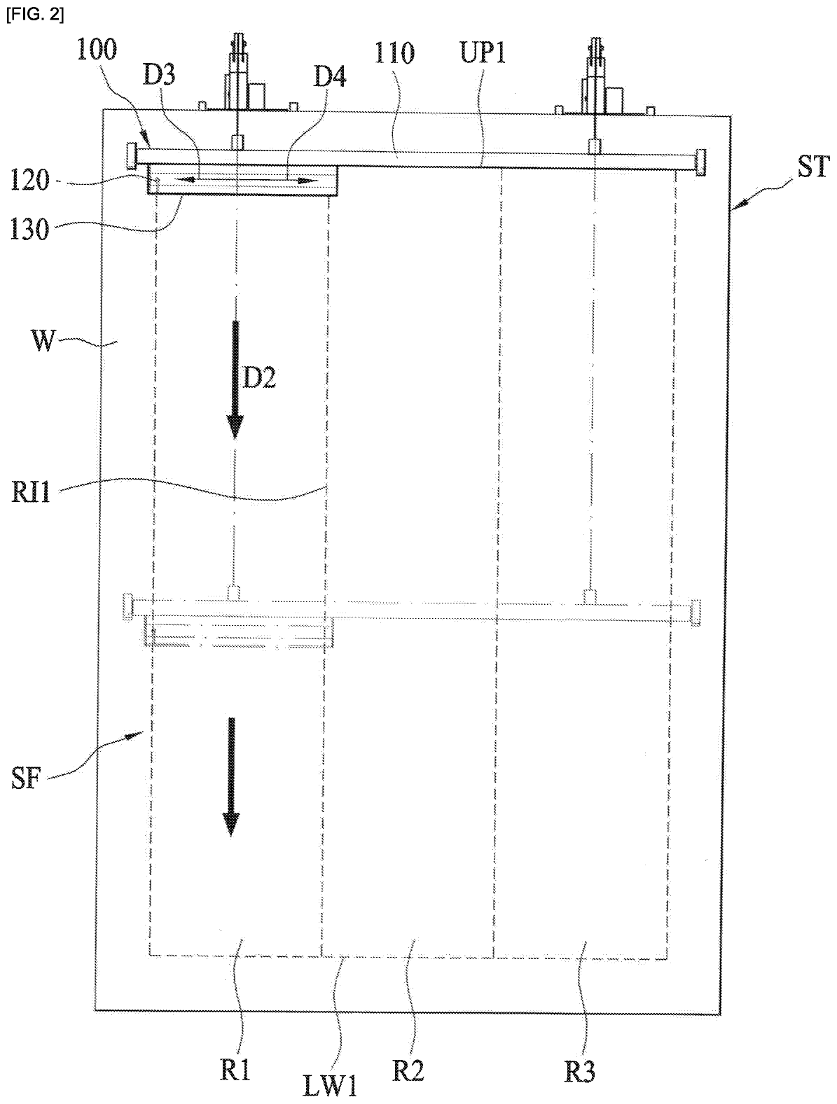

FIG. 1 is a schematic perspective view of an application apparatus according to one embodiment of the present invention and illustrating a state in which the application apparatus according to one embodiment of the present invention is located on a wall surface of a structure, and FIGS. 2 to 7 are views illustrating a situation in which paint is applied to the wall surface of the structure by the application apparatus according to one embodiment of the present invention.

First, referring to FIG. 1, an application apparatus 100 according to one embodiment of the present invention may be an apparatus configured to apply paint to a target surface SF that is at least a part of a wall surface W of a structure ST.

The application apparatus 100 may be used as an apparatus configured to apply paint to the target surface SF and also be used as an apparatus configured to print a particular image, with paint, on the target surface SF that is at least a part of the wall surface W of the structure ST.

Here, the image may be a concept including a picture, text, symbol, logo, and the like.

Also, the application apparatus 100 may be used as an apparatus configured to spray a coating agent to coat the wall surface W of the structure ST or used as an apparatus configured to spray a cleaning agent such as water or the like to clean the wall surface W, or the like.

Hereinafter, a case in which the application apparatus 100 is used as an apparatus configured to apply paint to the target surface SF that is at least a part of the wall surface W of the structure ST will be described as an example.

The application apparatus 100 may include a first moving portion 110, a spraying portion 120, and the like.

The first moving portion 110 may be a certain type of frame which is formed long in a lateral direction D3-D4 to be movable in a vertical direction D1-D2 according to a change in a length of a wire W1 caused by driving of a winch drum D installed on a rooftop or the like of the structure ST.

The first moving portion 110 may extend along the lateral direction D3-D4 of the target surface SF so as to cover a range according to the lateral direction D3-D4 of the target surface SF.

The target surface SF is at least a part of the wall surface W of the structure ST and may refer to a surface which needs an application of paint.

The spraying portion 120 may include a certain type of spray nozzle configured to be movable in a leftward direction D3 or a rightward direction D4 along the first moving portion 110 and to directly spray paint onto the target surface SF so as to apply the paint in a range from a predetermined left line LE1 (refer to FIG. 2) to a predetermined right line RI1 (refer to FIG. 2) of the target surface SF on the basis of the lateral direction D3-D4.

Here, the spraying portion 120 is not limited to directly spraying the paint onto the target surface SF and may spray the paint onto an application roller configured to rotate in contact with the target surface SF.

That is, to apply paint to the target surface SF, the application apparatus 100 according to the present invention may directly spray paint onto the target surface SF or may spray paint onto the application roller and then allow the paint to be applied to the target surface SF through rotation of the application roller.

The first moving portion 110 may be movable in the vertical direction D1-D2 to allow the spraying portion 120 to be movable from an uppermost line UP1 to a lowermost line LW1 of the target surface SF.

Meanwhile, when the target surface SF is divided into a plurality of regions along the lateral direction D3-D4 on the basis of a moving range of the spraying portion 120 in the lateral direction D3-D4, the predetermined left line LE1 to the predetermined right line RI1 in a case in which the application apparatus 100 according to the present invention directly sprays paint onto the target surface SF to apply the paint to the target surface SF may be an outermost left line and an outermost right line for a specific region and may be changed by a second moving portion 130 on which the spraying portion 120 is mounted.

That is, the predetermined left line LE1 and the predetermined right line RI1 relate to a range in which the spraying portion 120 is movable on the second moving portion 130 in the lateral direction D3-D4. When the first moving portion 110 is disposed at a particular position on the target surface SF and the second moving portion 130 is disposed at a particular position on the first moving portion 110, lines, in the vertical direction D1-D2, of a maximum range in which the spraying portion 120 is movable in the lateral direction D3-D4 on the second moving portion 130 along the second moving portion 130 are the predetermined left line LE1 and the predetermined right line RI1.

Meanwhile, the predetermined left line LE1 and the predetermined right line RI1 in a case in which the application apparatus 100 according to the present invention sprays paint onto the application roller and then allows the paint to be applied to the target surface SF through the rotation of the application roller may be considered as being divided into two types.

First, when the first moving portion 110 is disposed at a particular position on the target surface SF and the second moving portion 130 is disposed at a particular position on the first moving portion 110 while the application roller is rotatable around a random axis along the vertical direction D1-D2, lines, in the vertical direction D1-D2, of a maximum range in which the application roller and the spraying portion 120 spraying the paint onto the application roller are movable in the lateral direction D3-D4 on the second moving portion 130 along the second moving portion 130 are the predetermined left line LE1 and the predetermined right line RI1.

Second, when the application roller is rotatable on the basis of a random axis along the lateral direction D3-D4, the predetermined left line LE1 and the predetermined right line RI1 may be equal to a width of the application roller along the lateral direction D3-D4.

Hereinafter, a case in which the application apparatus 100 according to the present invention directly sprays paint onto the target surface SF to apply the paint to the target surface SF will be described as an example.

The second moving portion 130 may be mounted on the first moving portion 110 to be movable on the first moving portion 110. The movement of the second moving portion 130 on the first moving portion 110 may be implemented by well-known movement devices such as rails, tracks, and the like and a detailed description thereof will be omitted.

Hereinafter, a situation in which the application apparatus 100 according to the present invention applies paint to the target surface that is at least a part of the wall surface W of the structure ST will be described in detail with reference to FIGS. 2 to 7.

Referring to FIG. 2, the application apparatus 100 according to the present invention is located on the wall surface W of the structure ST to apply paint to the target surface SF.

Here, as shown in the drawings, for example, the target surface SF which needs an application of paint may be divided into three regions including a first region R1, a second region R2, and a third region R3 and may relate to a range in which the spraying portion 120 is movable on the second moving portion 130 along the lateral direction D3-D4.

That is, the number of regions obtained by dividing the target surface SF may be determined by comparing a width of the target surface SF along the lateral direction D3-D4 with a movement distance of the spraying portion 120 on the second moving portion 130. In some cases, a width for each region in the lateral direction D3-D4 may be partitioned differently.

Meanwhile, although an order of applying paint to the regions by the application apparatus 100 according to the present invention is not particularly limited, hereinafter, an order in which the paint is sequentially applied to the first region R1, the second region R2, and the third region R3 will be described as an example.

Also, an application direction within one region may be at least one direction of a downward direction D2 and an upward direction D1.

For example, an application direction in the first region R1 may be a direction from an upper side toward a lower side, an application direction in the second region R2 may be a direction from a lower side toward an upper side, and an application direction in the third region R3 may be a direction from an upper side toward a lower side.

Also, a direction in which the spraying portion 120 is moved on the second moving portion 130 while spraying paint may be at least one direction of the leftward direction D3 and the rightward direction D4, and for example, the spraying portion 120 sprays paint while moving in the leftward direction D3 and simultaneously may spray paint while moving in the rightward direction D4.

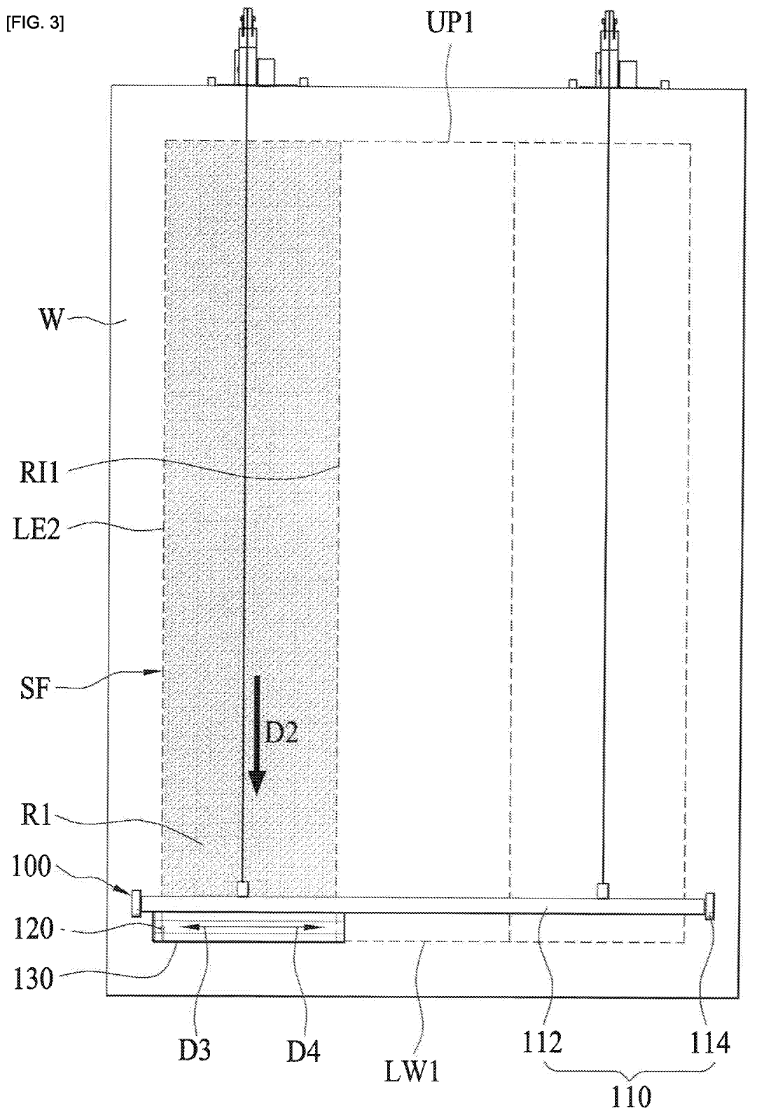

Referring to FIG. 3, the application apparatus 100 may apply paint to the first region R1 of the target surface SF and this may be implemented by movement of the first moving portion 110 in the downward direction D2 and movement of the spraying portion 120 on the second moving portion 130 along the lateral direction D3-D4.

In other words, after the spraying portion 120 sprays paint onto the target surface SF while moving on the second moving portion 130 in at least one direction of the leftward direction D3 and the rightward direction D4 in a state in which the first moving portion 110 is located at a first position on the basis of the vertical direction D1-D2, the first moving portion 110 is moved as much as a predetermined moving distance in the downward direction D2 to be located at a second position and then the spraying portion 120 repeats a process of spraying paint onto the target surface SF while moving again on the second moving portion 130 in at least one direction of the leftward direction D3 and the rightward direction D4 so as to complete applying of the paint to the first region R1.

Meanwhile, the first moving portion 110 may include a support portion 112 formed to extend, with a certain length, along the lateral direction D3-D4 of the target surface SF and configured to support movement of the spraying portion 120 in the lateral direction D3-D4 and a rotating portion 114 configured to rotate in contact with the target surface SF so as to be spaced apart from the target surface SF and moved while the first moving portion moves in the vertical direction D1-D2.

The rotating portion 114 is a component configured to allow the first moving portion 110 to easily move in the vertical direction D1-D2 and may be a certain type of wheel that is rotatable on the wall surface W of the structure ST.

Meanwhile, when the spraying portion 120 moves in at least one direction of the leftward direction D3 and the rightward direction D4 and sprays paint onto the target surface SF while the first moving portion 110 is located at the first position on the basis of the vertical direction D1-D2, the spraying portion 120 may spray the paint within a range between a predetermined left point corresponding to the first position and a predetermined right point corresponding to the first position while a distance from the first moving portion 110, that is, a linear distance along the vertical direction D1-D2 is uniformly maintained.

Here, the predetermined left point and the predetermined right point are present within a range from the predetermined left line LE1 to the predetermined right line RI1 and may be a point on an outermost left side and a point on an outermost right side which need an application of paint among lines along the lateral direction D3-D4 of the spraying portion 120 moved on the second moving portion 130 while the first moving portion 110 is located at the first position.

In the drawings, a case in which the predetermined left point and the predetermined right point are located on the predetermined left line and the predetermined right line, respectively, is illustrated.

A distance from the predetermined left point to the predetermined right point may be defined by the second moving portion 130, and in other words, may be present within a range in which the spraying portion 120 is movable on the second moving portion 130 in the lateral direction D3-D4.

The first moving portion 110 may be moved in only one direction of the upward direction D1 and the downward direction D2 and allow the paint to be sprayed by the spraying portion 120 to be applied to a certain area within a range from the predetermined left line LE1 to the predetermined right line RI1.

For example, the first moving portion 110 may be moved in the first region R1 only in the downward direction D2 and allow the paint to be applied to the first region R1.

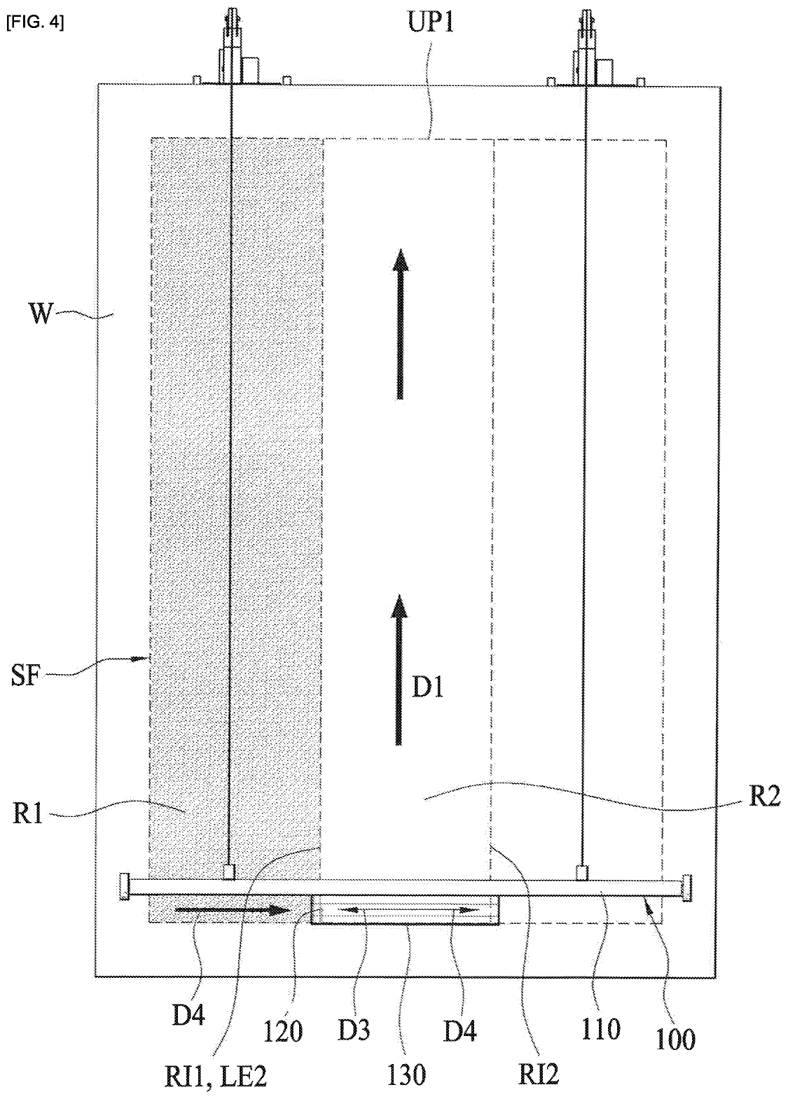

Referring to FIG. 4, when applying the paint to the first region R1 is completed, the application apparatus 100 according to the present invention starts applying paint to the second region R2.

To this end, the second moving portion 130 moves from a state shown in FIG. 3 in the rightward direction D4 along the first moving portion 110 so as to allow the spraying portion 120 to spray paint onto the second region R2.

In detail, when paint is applied to a certain area of the first region R1 within the range from the predetermined left line LE1 to the predetermined right line RI1 by the movement of the first moving portion 110 in the downward direction D2, the movement of the spraying portion 120 in the lateral direction D3-D4, and spraying of the paint by the spraying portion 120, the second moving portion 130 is moved along the first moving portion 110 so as to allow the spraying portion 120 to apply paint to a certain area within a range from another predetermined left line LE2 to another predetermined right line RI2 of the second region R2.

Meanwhile, the other predetermined left line LE2 may be the same as the predetermined right line RI1 to secure application continuity between the regions for realistic application, and this may be implemented by precisely controlling a moving distance of the second moving portion 130 on the first moving portion 110 in consideration of a position of the spraying portion 120 on the second moving portion 130.

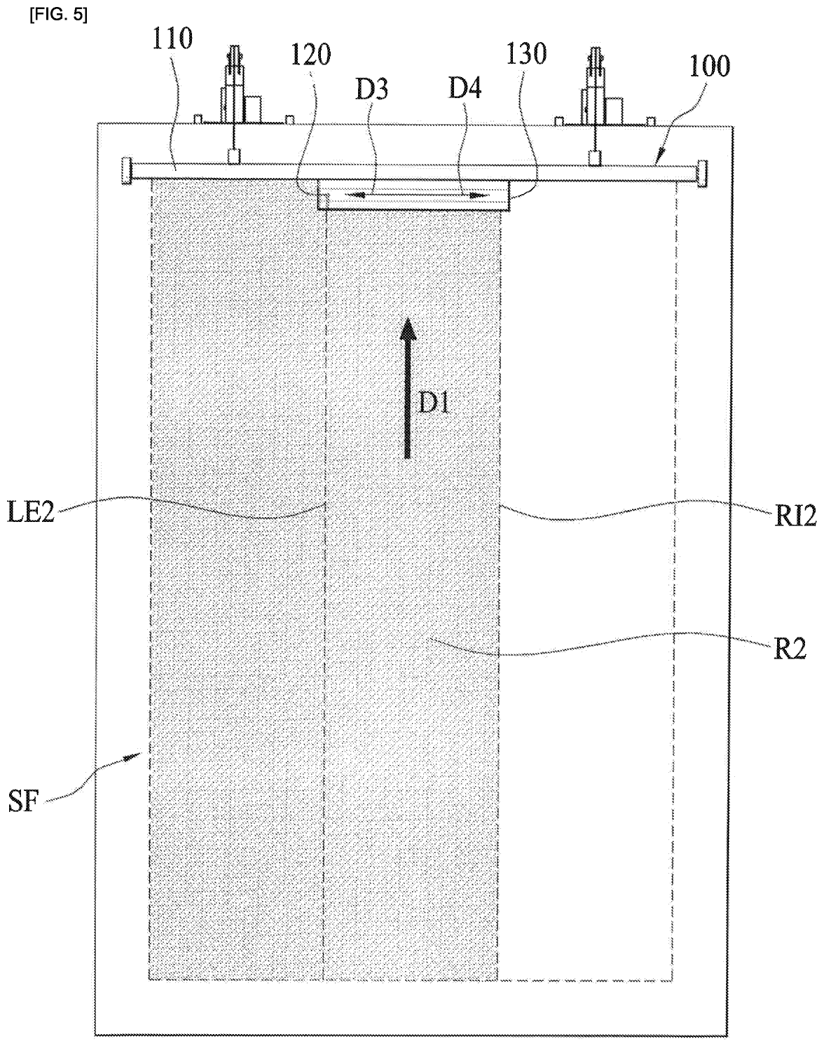

Referring to FIG. 5, the application apparatus 100 may apply paint to the second region R2 of the target surface SF and this may be implemented by movement of the first moving portion 110 in the upward direction D1 and movement of the spraying portion 120 on the second moving portion 130 along the lateral direction D3-D4.

In other words, after the spraying portion 120 sprays paint onto the target surface SF while moving on the second moving portion 130 in at least one direction of the leftward direction D3 and the rightward direction D4 in a state in which the first moving portion 110 is located at a third position on the basis of the vertical direction D1-D2, the first moving portion 110 is moved as much as a predetermined moving distance in the upward direction D1 to be located at a fourth position and then the spraying portion 120 repeats a process of spraying paint onto the target surface SF while moving again on the second moving portion 130 in at least one direction of the leftward direction D3 and the rightward direction D4 so as to complete applying of the paint to the second region R2.

Meanwhile, when the spraying portion 120 moves in at least one direction of the leftward direction D3 and the rightward direction D4 and sprays paint onto the target surface SF while the first moving portion 110 is located at the third position on the basis of the vertical direction D1-D2, the spraying portion 120 may spray the paint within a range between another predetermined left point corresponding to the third position and another predetermined right point corresponding to the third position while a distance from the first moving portion 110, that is, a linear distance along the vertical direction D1-D2 is uniformly maintained.

Here, the other predetermined left point and the other predetermined right point are present within a range from the other predetermined left line LE2 to the other predetermined right line RI2 and may be a point on an outermost left side and a point on an outermost right side which need an application of paint among lines along the lateral direction D3-D4 of the spraying portion 120 moved on the second moving portion 130 while the first moving portion 110 is located at the third position.

In the drawings, a case in which the other predetermined left point and the other predetermined right point are located on the other predetermined left line and the other predetermined right line, respectively, is illustrated.

A distance between the other predetermined left point and the other predetermined right point may be defined by the second moving portion 130, and in other words, may be present within a range in which the spraying portion 120 is movable on the second moving portion 130 in the lateral direction D3-D4.

The first moving portion 110 may be moved in only one direction of the upward direction D1 and the downward direction D2 and allow the paint to be sprayed by the spraying portion 120 to be applied to a certain area within a range from the other predetermined left line LE2 to the other predetermined right line RI2.

For example, the first moving portion 110 may be moved in the second region R2 only in the upward direction D1 and allow the paint to be applied to the second region R2.

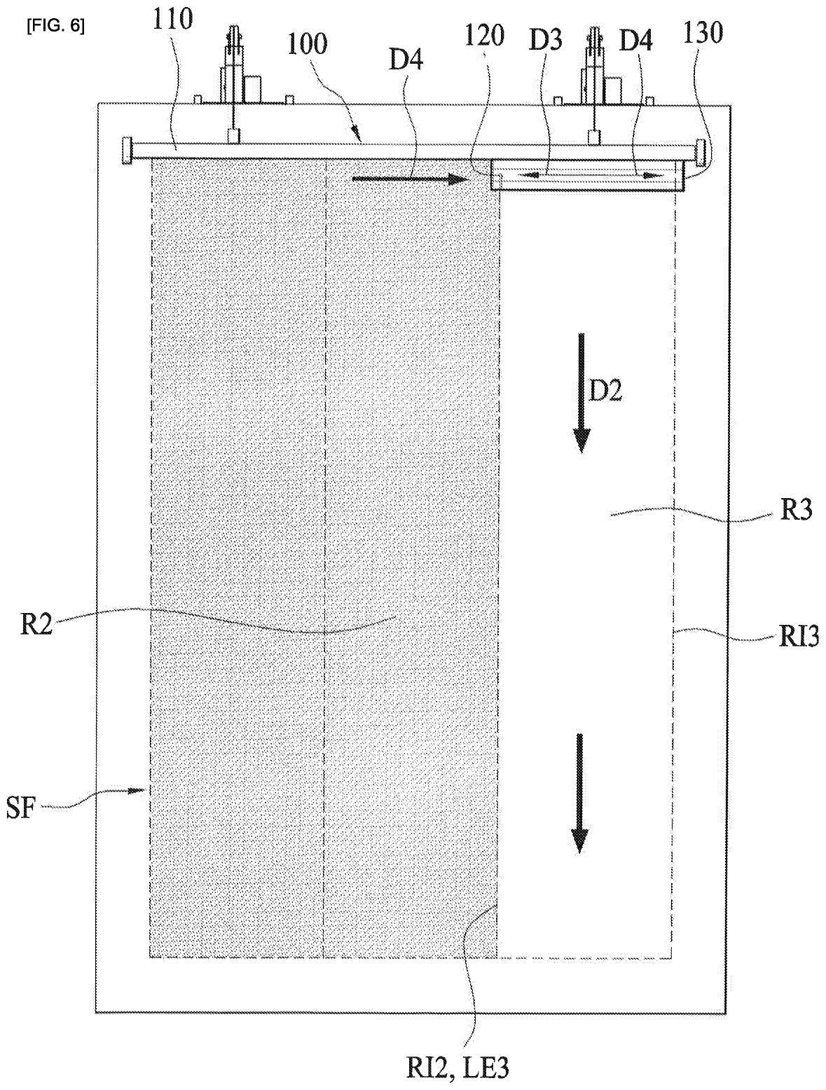

Referring to FIG. 6, when applying the paint to the second region R2 is completed, the application apparatus 100 according to the present invention starts applying paint to the third region R3.

To this end, the second moving portion 130 may move from a state shown in FIG. 5 in the rightward direction D4 along the first moving portion 110 so as to allow the spraying portion 120 to spray paint onto the third region R3.

In detail, when paint is applied to a certain area of the second region R2 within the range from the other predetermined left line LE2 to the other predetermined right line RI2 by the movement of the first moving portion 110 in the upward direction D1, the movement of the spraying portion 120 in the lateral direction D3-D4, and spraying of the paint by the spraying portion 20, the second moving portion 130 is moved along the first moving portion 110 so as to allow the spraying portion 120 to apply paint to a certain area within a range from still another predetermined left line LE3 to still another predetermined right line RI3 of the third region R3.

Meanwhile, the still another predetermined left line LE3 may be the same as the other predetermined right line RI2 to secure application continuity between the regions for realistic application, and this may be implemented by precisely controlling a moving distance of the second moving portion 130 on the first moving portion 110 in consideration of a position of the spraying portion 120 on the second moving portion 130.

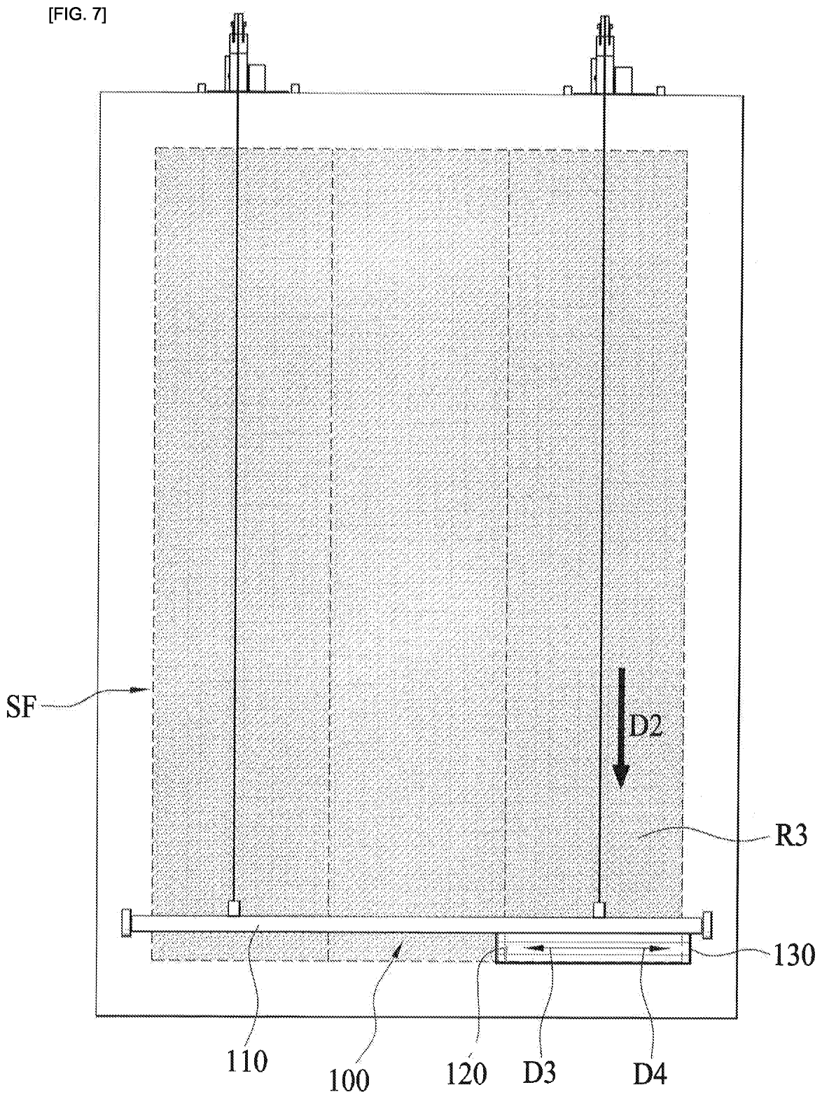

Referring to FIG. 7, the application apparatus 100 may apply paint to the third region R3 of the target surface SF and this may be implemented by movement of the first moving portion 110 in the downward direction D2 and movement of the spraying portion 120 on the second moving portion 130 along the lateral direction D3-D4.

In other words, after the spraying portion 120 sprays paint onto the target surface SF while moving on the second moving portion 130 in at least one direction of the leftward direction D3 and the rightward direction D4 in a state in which the first moving portion 110 is located at a fifth position on the basis of the vertical direction D1-D2, the first moving portion 110 is moved as much as a predetermined moving distance in the downward direction D2 to be located at a sixth position and then the spraying portion 120 repeats a process of spraying paint onto the target surface SF while moving again on the second moving portion 130 in at least one direction of the leftward direction D3 and the rightward direction D4 so as to complete applying of the paint to the third region R3.

Meanwhile, when the spraying portion 120 moves in at least one direction of the leftward direction D3 and the rightward direction D4 and sprays paint onto the target surface SF while the first moving portion 110 is located at the fifth position on the basis of the vertical direction D1-D2, the spraying portion 120 may spray the paint within a range between still another predetermined left point corresponding to the fifth position and still another predetermined right point corresponding to the fifth position while a distance from the first moving portion 110, that is, a linear distance along the vertical direction D1-D2 is uniformly maintained.

Here, the still another predetermined left point and the still another predetermined right point are present within a range from the still another predetermined left line LE3 to the still another predetermined right line RI3 and may be a point on an outermost left side and a point on an outermost right side which need an application of paint among lines along the lateral direction D3-D4 of the spraying portion 120 moved on the second moving portion 130 while the first moving portion 110 is located at the fifth position.

In the drawings, a case in which the still another predetermined left point and the still another predetermined right point are located on the still another predetermined left line and the still another predetermined right line, respectively, is illustrated.

A distance between the still another predetermined left point to the still another predetermined right point may be defined by the second moving portion 130, and in other words, may be present within a range in which the spraying portion 120 is movable on the second moving portion 130 in the lateral direction D3-D4.

The first moving portion 110 may be moved in only one direction of the upward direction D1 and the downward direction D2 and allow the paint to be applied by the spraying portion 120 to a certain area within a range from the still another predetermined left line LE3 to the still another predetermined right line RI3.

For example, the first moving portion 110 may be moved in the third region R3 only in the downward direction D2 and allow the paint to be applied to the third region R3.

As described above, in the application apparatus 100 according to the present invention, the movement of the spraying portion 120 in the vertical direction D1-D2 may be implemented by the movement of the first moving portion 110 in the vertical direction D1-D2. Also, when application is performed within one region, the first moving portion 110 is moved in only one direction of the upward direction D1 and the downward direction D2 and performs application so as to significantly reduce an application time.

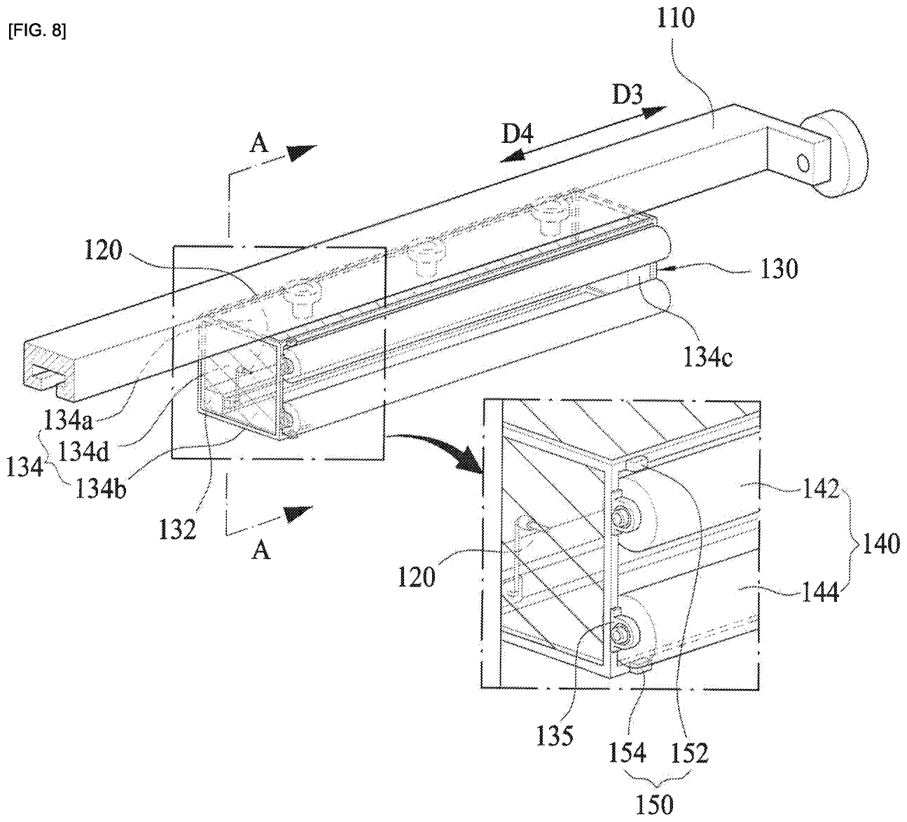

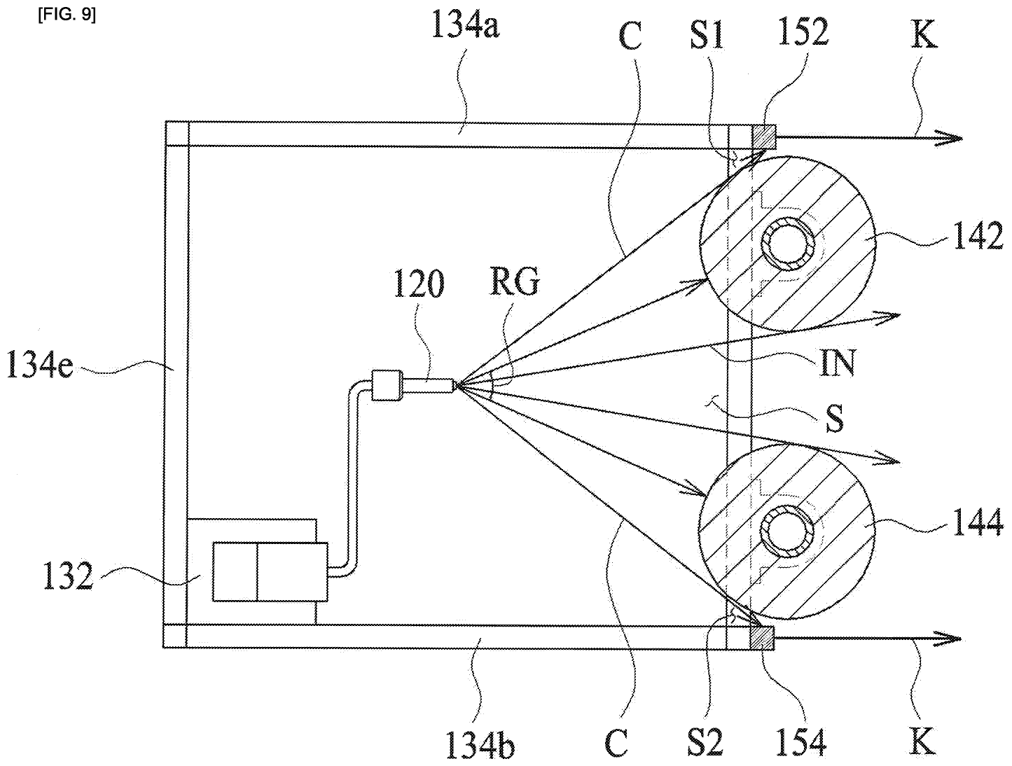

FIG. 8 is a schematic perspective view illustrating the second moving portion provided in the application apparatus according to one embodiment of the present invention, and FIG. 9 is a schematic cross-sectional view taken along line AA of FIG. 8.

Referring to FIGS. 8 and 9, the second moving portion 130 may be moved along the first moving portion 110 in the lateral direction D3-D4, and this may be implemented by a power providing portion such as a motor or like which is not shown and may be implemented by transmitting power through a component such as a variety of gears and the like.

Power provision or the like of the power providing portion may be automatically implemented by a control portion or the like which is not shown.

The second moving portion 130 may include a lateral support frame 132 configured to support movement of the spraying portion 120 in the lateral direction D3-D4 and define a movement range in the lateral direction D3-D4, a front-rear support frame configured to support movement of the spraying portion 120 in a front-rear direction and define a movement range in the front-rear direction, and a mounting frame 134 configured to cover an upper side and a lower side of the spraying portion 120.

Here, the spraying portion 120 may spray paint supplied from a paint storage portion in which the paint is stored onto the target surface, and spraying of the paint through the spraying portion 120 may be implemented by a compressed air portion configured to supply compressed air so as to provide a spraying force.

A pressure of the compressed air may be adjusted by a pressure adjusting portion so that the spraying force of the paint through the spraying portion 120 may be adjusted.

Here, a thickness of a paint film formed on the target surface SF may be adjusted according to a level of the spraying force of the paint and may be adjusted by adjusting the number of times the spraying portion 120 is moved on the second moving portion 130 in the lateral direction D3-D4.

The paint supplied from the paint storage portion to the spraying portion 120 may be dehydrated by a dehydration portion so that the paint sprayed from the spraying portion 120 may be prevented from flowing down the target surface.

A dust-collecting device may be located inside the second moving portion 130, and the dust-collecting device may prevent foreign matter and the like from being included in the paint sprayed from the spraying portion 120.

Meanwhile, the lateral support frame 132 of the second moving portion 130 may be a well-known movement device such as rails, tracks, and the like configured to support and implement the movement of the spraying portion 120 in the lateral direction D3-D4 and may be surrounded by the mounting frame 134.

Movement according to the lateral support frame 132 of the spraying portion 120 may be implemented by a power providing portion such as a motor or the like which is not shown and may be implemented by transmitting power through a component such as a variety of gears and the like.

Power provision or the like of the power providing portion may be automatically implemented by a control portion or the like which is not shown.

The front-rear support frame of the second moving portion 130 is a component configured to support movement of the spraying portion 120 in the front-rear direction, and the movement in the front-rear direction may be implemented by the power providing portion such as a motor or the like which is not shown and may be implemented by transmitting power through a component such as a variety of gears and the like.

The movement of the spraying portion 120 in the front-rear direction may be automatically implemented on the basis of a degree of curvature or a degree of protruding of the target surface but is not necessarily limited thereto and may be manually implemented.

The mounting frame 134 of the second moving portion 130 may be formed to have a certain polygonal box shape, for example, a quadrangular box shape with an open front but is not limited thereto and may have a cylindrical shape or the like with an open front.

Hereinafter, a case in which the mounting frame 134 is formed to have a quadrangular box shape with an open front will be described as an example.

The mounting frame 134 may include an upper cover frame 134a, a lower cover frame 134b, a left cover frame 134c, a right cover frame 134d, and a rear cover frame 134e which cover an upper side, a lower side, a left side, a right side, and a rear side of the spraying portion 120, respectively.

Meanwhile, a first scattering prevention portion 140 and a second scattering prevention portion 150 may be mounted on the second moving portion 130. The first scattering prevention portion 140 and the second scattering prevention portion 150 may be disposed in front of the spraying portion 120 and prevent the paint sprayed through the spraying portion 120 from scattering.

The first scattering prevention portion 140 may absorb the paint sprayed through the spraying portion 120 to prevent the paint from scattering and may rotate due to contact with the target surface SF.

A part of the first scattering prevention portion 140 may be located within a spraying range RG of the paint IN sprayed through the spraying portion 120 or an entirety thereof may be located within the spraying range RG of the paint IN sprayed through the spraying portion 120.

In other words, at least a part of the first scattering prevention portion 140 may be located within the spraying range RG of the paint IN sprayed through the spraying portion 120.

Conversely, a part of the first scattering prevention portion 140 may be located outside a spraying range RG of the paint IN sprayed through the spraying portion 120 or an entirety thereof may be located outside the spraying range RG of the paint IN sprayed through the spraying portion 120.

In other words, at least a part of the first scattering prevention portion 140 may be located outside the spraying range RG of the paint IN sprayed through the spraying portion 120.

The first scattering prevention portion 140 may include a 1-1 scattering prevention portion 142 and a 1-2 scattering prevention portion 144 which are disposed on an upper front side and a lower front side of the spraying portion 120, respectively.

The 1-1 scattering prevention portion 142 may prevent paint sprayed from the spraying portion 120 from scattering upward, and the 1-2 scattering prevention portion 144 may prevent paint sprayed from the spraying portion 120 from scattering downward.

Here, the 1-1 scattering prevention portion 142 and the 1-2 scattering prevention portion 144 may be disposed to be spaced apart to form a spraying space S configured to allow the paint sprayed through the spraying portion 120 to be directly sprayed onto the target surface SF.

The 1-1 scattering prevention portion 142 and the 1-2 scattering prevention portion 144 may be formed as cylindrical sponges and may be rotated based on the mounting frame 134 due to contact with the target surface SF.

That is, the 1-1 scattering prevention portion 142 and the 1-2 scattering prevention portion 144 may be rolled by the contact with the target surface SF when the mounting frame 134, the lateral support frame 132, or the spraying portion 120 moves in the vertical direction D2, that is, the first moving portion 110 moves in the vertical direction D1-D2.

In other words, the 1-1 scattering prevention portion 142 and the 1-2 scattering prevention portion 144 may be movable in the vertical direction D1-D2 in connection with the movement of the spraying portion 120 in the vertical direction D1-D2.

The 1-1 scattering prevention portion 142 and the 1-2 scattering prevention portion 144 may each include a width corresponding to a width of the mounting frame 134 in the lateral direction D3-D4. In other words, to correspond to a moving range of the spraying portion 120 on the lateral support frame 132 in the lateral direction D3-D4, the 1-1 scattering prevention portion 142 and the 1-2 scattering prevention portion 144 may be disposed lengthwise along the lateral direction D3-D4.

Also, the 1-1 scattering prevention portion 142 and the 1-2 scattering prevention portion 144 may be located on the mounting frame 134 to protrude further than the mounting frame 134. On the other hand, the mounting frame 134 may be disposed to be spaced apart from the target surface SF when the 1-1 scattering prevention portion 142 and the 1-2 scattering prevention portion 144 come into contact with the target surface SF.

This is to prevent the mounting frame 134 from coming into contact with the target surface SF because the 1-1 scattering prevention portion 142 and the 1-2 scattering prevention portion 144 are formed of sponges and slightly contract when coming into contact with the target surface SF.

Meanwhile, the 1-1 scattering prevention portion 142 and the 1-2 scattering prevention portion 144 may be rotatably mounted on rotation-supporting portions 135 installed on the left cover frame 134c and the right cover frame 134d, respectively.

Here, parts of the 1-1 scattering prevention portion 142 and the 1-2 scattering prevention portion 144 in the lateral direction D3-D4 may prevent the paint sprayed through the spraying portion 120 from scattering using the left cover frame 134c and the right cover frame 134d.

Also, other parts of the 1-1 scattering prevention portion 142 and the 1-2 scattering prevention portion 144 in the lateral direction D3-D4, that is, front sides of the left cover frame 134c and the right cover frame 134d may be closed by an additional component, for example, an additional sponge or barrier or may be closed by modifying shapes of the left cover frame 134c and the right cover frame 134d, for example, by modifying shapes into a T-shape protruding toward the spraying space S.

Meanwhile, the first scattering prevention portion 140 including the 1-1 scattering prevention portion 142 and the 1-2 scattering prevention portion 144 may move in position on the basis of the mounting frame 134 so as to change a positional relationship with respect to the spraying portion 120.

The 1-1 scattering prevention portion 142 and the 1-2 scattering prevention portion 144 may be automatically or manually moved to optimal positions in consideration of the spraying range RG according to the spraying force of the spraying portion 120, and there is no limitation in a device configured to implement positional movement.

Meanwhile, although not shown in the drawings, a plurality of such spraying portions 120 may be provided.

For example, the spraying portion 120 may include a first spraying portion and a second spraying portion which are disposed in the vertical direction D1-D2, and the first spraying portion and the second spraying portion may be mounted in the lateral support frame 132 to be independently movable on the lateral support frame 132.

In this case, a plurality of such lateral support frames 132 may be arranged in the vertical direction D1-D2 but the present invention is not limited thereto and the first spraying portion and the second spraying portion may be implemented to be movable on one lateral support frame 132 in the lateral direction D3-D4.

Also, in this case, in consideration of a spraying range of the first spraying portion and a spraying range of the second spraying portion, positions of the 1-1 scattering prevention portion 142 and the 1-2 scattering prevention portion 144 may be adjusted.

Meanwhile, in the present invention, to maximize an effect of preventing scattering, a second scattering prevention portion 150 may be further included in addition to the above-described 1-1 scattering prevention portion 142 and 1-2 scattering prevention portion 144.

The second scattering prevention portion 150 may be disposed outside the first scattering prevention portion 140 and expand a range of preventing the paint from scattering.

In detail, to prevent the paint sprayed from the spraying portion 120 from scattering through a space S1 between the 1-1 scattering prevention portion 142 and the upper cover frame 134a, the second scattering prevention portion 150 may include a 2-1 scattering prevention portion 152 disposed above the 1-1 scattering prevention portion 142 and configured to spray high-pressure air.

Also, to prevent the paint sprayed from the spraying portion 120 from scattering through a space S2 between the 1-2 scattering prevention portion 144 and the lower cover frame 134b, the second scattering prevention portion 150 may include a 2-2 scattering prevention portion 154 disposed below the 1-2 scattering prevention portion 144 and configured to spray high-pressure air.

Here, when the 1-1 scattering prevention portion 142 is rotated on the mounting frame 134 by contact with the target surface SF, to prevent interference with the upper cover frame 134a, it is necessary to dispose the 1-1 scattering prevention portion 142 spaced part from the upper cover frame 134a. When 1-2 scattering prevention portion 144 is rotated on the mounting frame 134 by contact with the target surface SF, to prevent interference with the lower cover frame 134b, it is necessary to dispose the 1-2 scattering prevention portion 144 spaced apart from the lower cover frame 134b.

However, although the effect of preventing the paint from scattering is implemented by the 1-1 scattering prevention portion 142 and the 1-2 scattering prevention portion 144, only using the 1-1 scattering prevention portion 142 and the 1-2 scattering prevention portion 144, it is hard to completely exclude the possibility that the paint scatters through the spaces S1 and S2 as shown with an arrow C due to an error, by a worker, in setting a position of the spraying portion 120, manipulating a spraying pressure or the like, or a change in an external environment or the like.

Accordingly, in the present invention, it is possible to maximize a scattering prevention effect adapted to a variety of environmental changes through the 2-1 scattering prevention portion 152 and the 2-2 scattering prevention portion 154 which are configured to form air curtains above the 1-1 scattering prevention portion 142 and below the 1-2 scattering prevention portion 144 by spraying high-pressure air K.

The above-described 2-1 scattering prevention portion 152 and 2-2 scattering prevention portion 154 may be disposed to be movable in the lateral direction D3-D4 in connection with the movement of the spraying portion 120 on the lateral support frame 132 in the lateral direction D3-D4.

In other words, the 2-1 scattering prevention portion 152 and the 2-2 scattering prevention portion 154 may be mounted on a front side of the upper cover frame 134a to be movable and may be movable along the front side of the upper cover frame 134a. To this end, the front side of the upper cover frame 134a may be formed as a certain type of track.

Here, movement of the 2-1 scattering prevention portion 152 and the 2-2 scattering prevention portion 154 along the upper cover frame 134a may be implemented by a power providing portion such as a motor or the like which is not shown and may be implemented by transmitting power through a component such as a variety of gears and the like.

Power provision or the like of the power providing portion may be automatically implemented by a control portion or the like which is not shown.

Meanwhile, the 2-1 scattering prevention portion 152 and the 2-2 scattering prevention portion 154 may be connected to the spraying portion 120 and may be moved with the spraying portion 120 in the lateral direction D3-D4 in connection therewith when the spraying portion 120 is moved along the lateral support frame 132 in the lateral direction D3-D4.

Also, the 2-1 pluralities of scattering prevention portions 152 and 2-2 scattering prevention portions 154 may be implemented as a fixed type to be disposed spaced apart along the lateral direction D3-D4 within a moving range of the spraying portion 120 on the lateral support frame 132 in the lateral direction D3-D4 or may be implemented as a movable type to be movable.

It has been described above that the scattering prevention effect is maximized by the 2-1 scattering prevention portion 152 and the 2-2 scattering prevention portion 154 which are configured to form an air curtain in the present invention.

Here, a direction in which the air curtain is formed may be implemented to be horizontal or oblique by adjusting a proceeding direction of high-pressure air sprayed from the 2-1 scattering prevention portion 152 and the 2-2 scattering prevention portion 154.

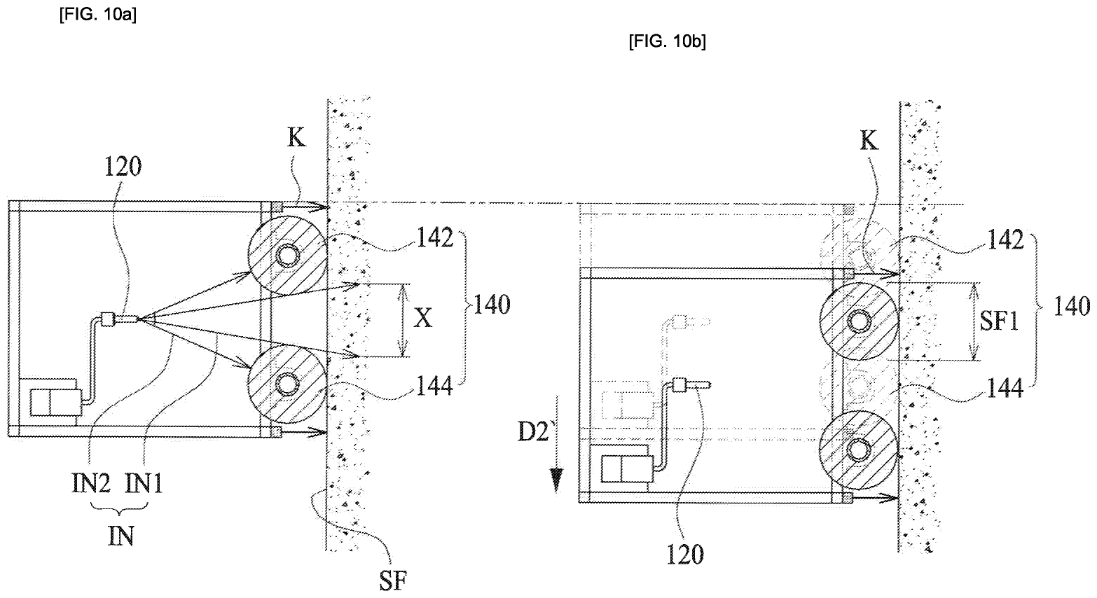

FIG. 10 is a schematic cross-sectional view taken along line AA of FIG. 8 and illustrating a reapplying function of the application apparatus according to one embodiment of the present invention.

Referring to FIG. 10, the application apparatus 100 according to one embodiment of the present invention may implement the reapplying function so as to maximize application performance.

Hereinafter, in a description on the reapplying function of the application apparatus 100 according to one embodiment of the present invention, the above-described first scattering prevention portion 140 will be described while being referred to as a reapplication portion 140.

Also, an element which will be described below as the reapplication portion 140 should be understood as including all features such as an objective, components, an effect, and the like of the above-described first scattering prevention portion 140.

As shown in FIG. 10A, the spraying portion 120 may spray the paint IN onto the target surface SF. In the paint IN, first paint IN1 is directly sprayed onto the target surface SF and second paint IN2 is absorbed by the reapplication portion 140.

Here, the second paint IN2 may be a concept which means paint that is a part of the paint IN sprayed from the spraying portion 120 and sprayed onto the reapplication portion 140, instead of being directly sprayed onto the target surface SF, to be absorbed by the reapplication portion 140.

The reapplication portion 140 may include a first reapplication portion 142 and a second reapplication portion 144 which are disposed above and below the spraying portion 120, respectively. The first reapplication portion 142 and the second reapplication portion 144 may be formed of cylindrical sponges and rotatably mounted on the mounting frame 134.

The reapplication portion 140 may absorb the second paint IN2 and apply the absorbed second paint IN2 to the target surface SF so that the first paint IN1 sprayed from the spraying portion 120 may be directly sprayed onto and primarily applied to the target surface SF as shown in FIG. 10A and then the absorbed second paint IN2 may be secondarily applied to the surface target as shown in FIG. 10B.

For convenience of description, when a part of the target surface is defined as a first target surface SF1, as shown in FIG. 10A, paint sprayed by the spraying portion 120, that is, the first paint IN1 may be directly sprayed onto and primarily applied to the first target surface SF1.

Subsequently, when the spraying portion 120 is moved in the vertical direction D1-D2, that is, in the downward direction D2 as shown in FIG. 10B, the first reapplication portion 142 is rotated by contact with the target surface SF to be moved to the first target surface SF1 and secondarily applies the paint to the first target surface SF1.

When the spraying portion 120 is moved in the downward direction D2 and located at a position shown in FIG. 10A, the second reapplication portion 144 preferentially applies the paint to the first target surface SF1.

Through a series of processes as described above, the paint may be applied a plurality of times to the target surface SF by the reapplication portion 140 so as to maximize application performance.

Also, the reapplication portion 140 used for preferentially applying the paint to a particular target surface SF may vary according to a moving direction of the spraying portion 120.

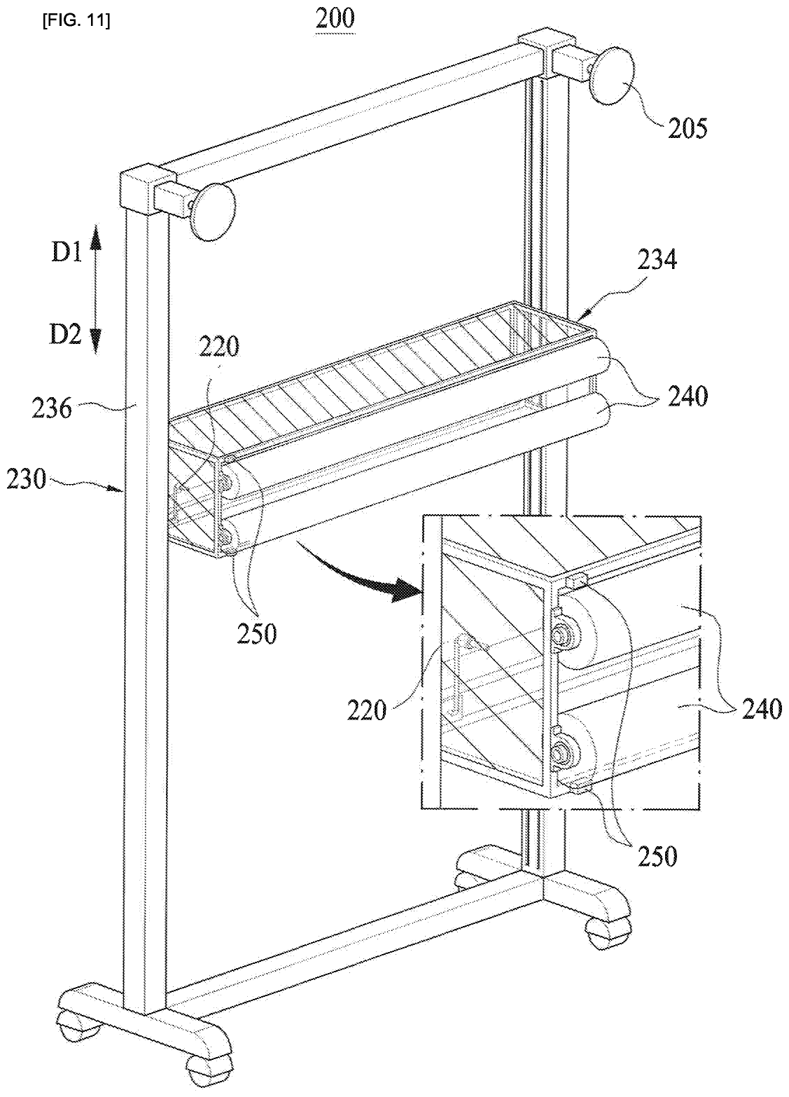

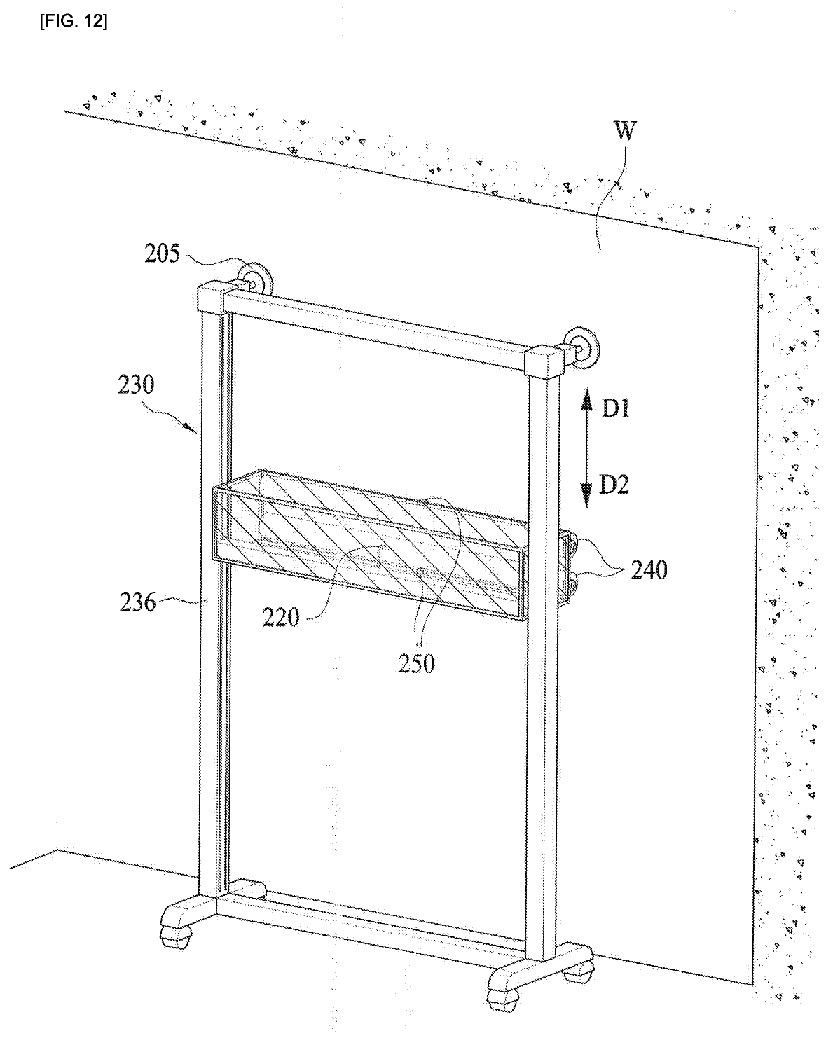

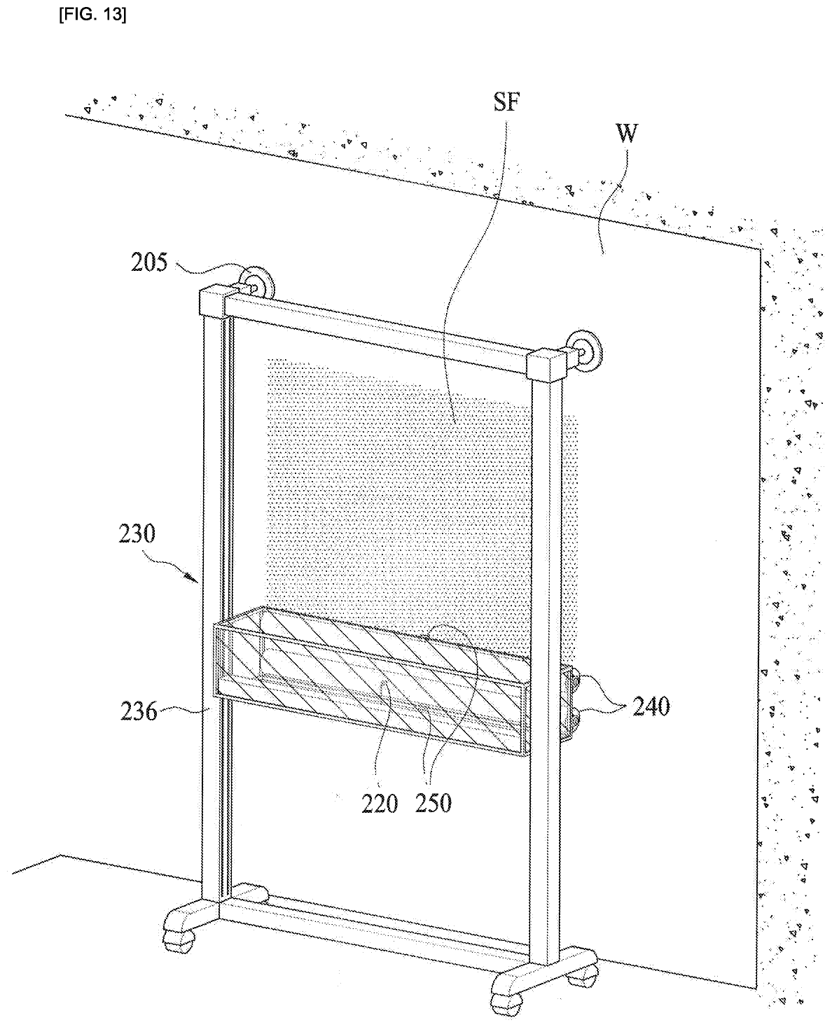

FIG. 11 is a schematic perspective view illustrating an application apparatus according to another embodiment of the present invention, FIG. 12 is a schematic perspective view illustrating a state in which the application apparatus according to another embodiment of the present invention is located on a wall surface of a structure, and FIG. 13 is a schematic perspective view illustrating a process in which the application apparatus according to one embodiment of the present invention applies paint to an inner wall of a structure.

Referring to FIGS. 11 to 13, an application apparatus 200 according to another embodiment of the present invention may be installed on a wall surface W in a different method in comparison to the application apparatus 100 according to one embodiment of the present invention described above with reference to FIGS. 1 to 10.

That is, the application apparatus 200 according to another embodiment of the present invention may be automatically or manually moved using wheels which come into contact with the ground to apply paint to the target surface SF that is at least a part of the wall surface W of the structure.

However, the application apparatus 200 according to another embodiment of the present invention may be located on the target surface SF of the wall surface W of the structure by a crane or the like and may be located on the target surface by a winch drum or the like installed on a rooftop or the like of the structure like the application apparatus 100 according to one embodiment of the present invention.

The application apparatus 200 according to another embodiment of the present invention may include a position guiding portion 205 which comes into contact with the wall surface W of the structure to be located at a preferable position of the target surface SF, and the position guiding portion 205 may elongate and contract.

The position guiding portion 205 may be, for example, an suction pad.

The application apparatus 200 according to another embodiment of the present invention may include a frame 230 including a vertical support frame 236 which is an element equivalent to the second moving portion 130 included in the application apparatus 100 according to one embodiment of the present invention.

The vertical support frame 236 may be a well-known movement device such as a certain type of rails, tracks, and the like configured to support and implement movement of a lateral support frame 232 in the vertical direction D1-D2 to allow the spraying portion 220 to spray paint along the vertical direction D1-D2.

Here, a mounting frame 234 may be mounted on the vertical support frame 236 to be movable in the vertical direction D1-D2 but is not limited thereto and the lateral support frame 232 in the mounting frame 234 may be mounted to be movable on the vertical support frame 236.

Movement of the mounting frame 234 according to the vertical support frame 236 may be implemented by a power providing portion such as a motor or the like which is not shown and may be implemented by transmitting power through a component such as a variety of gears and the like.

Power provision or the like of the power providing portion may be automatically implemented by a control portion or the like which is not shown.

Meanwhile, like the application apparatus 100 according to one embodiment of the present invention, the application apparatus 200 according to another embodiment of the present invention may include a first scattering prevention portion 240 and a second scattering prevention portion 250 and may further include a third scattering prevention portion (not shown).

The third scattering prevention portion may be an element mounted on the vertical support frame 236 and coming into contact with the wall surface W to prevent the paint from scattering outward from a left side or outward from a right side of the mounting frame 234 when the frame 230 approaches the wall surface W and the spraying portion 220 sprays paint onto the target surface SF.

The third scattering prevention portion may be implemented to have elasticity or to elongate or contract so as to be changed in state, for example, may be implemented to have a shape like a bellows.

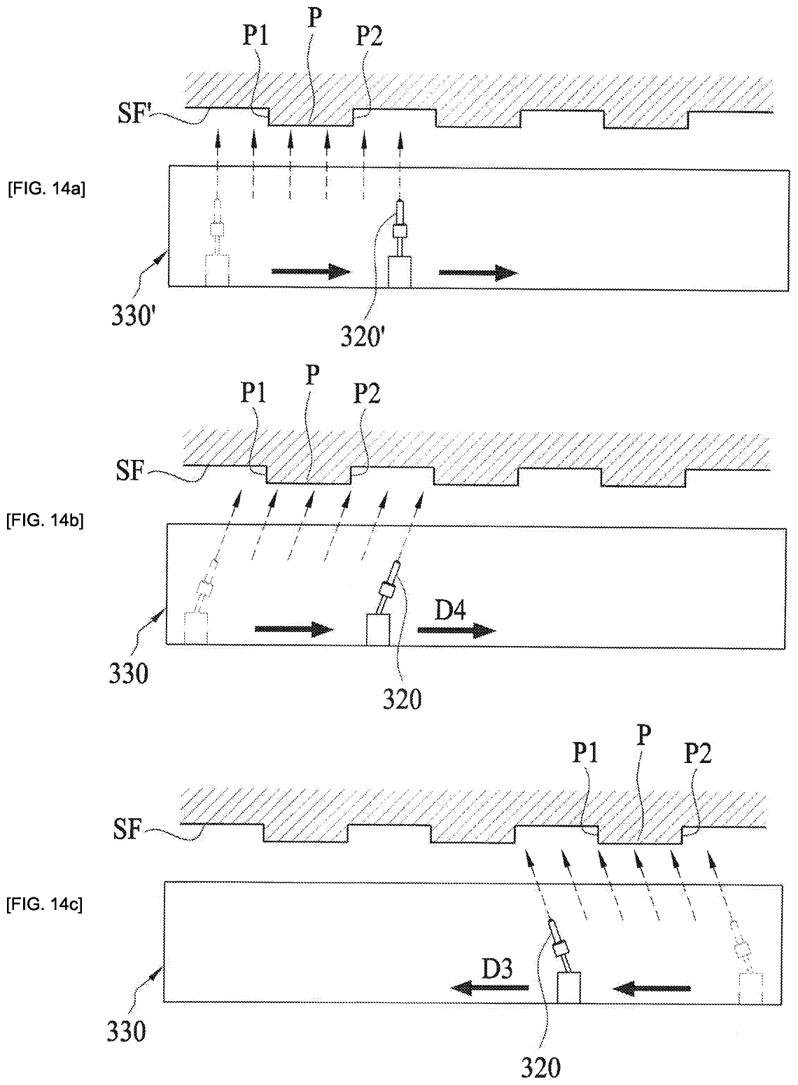

FIG. 14 is a view illustrating a first control method of a spraying portion provided in an application apparatus according to the present invention.

First, although a first control method of a spraying portion 320 is applicable to all of the above-described embodiments, hereinafter, the application apparatus 100 according to one embodiment of the present invention which has been described above with reference to FIGS. 1 to 10 will be described as an example.

In addition, the second moving portion 130 provided in the application apparatus 100 according to one embodiment of the present invention which has been described above with reference to FIGS. 1 to 10 will be described while being referred to as a frame 330.

Referring to FIG. 14, while the spraying portion 320 is mounted on the frame 330 to be movable in the lateral direction D3-D4, a spraying direction thereof may be adjusted by a control portion.

The control portion is one element of the application apparatus 100 according to the present invention and may control the overall application operation such as a spraying pressure and spraying direction of paint sprayed by the spraying portion 320, movement of the first moving portion 110 in the vertical direction D1-D2, movement of the frame 330 on the first moving portion 110, and the like.

When the spraying portion 320 sprays and applies paint (on) to the target surface SF while moving along the target surface in the lateral direction D3-D4, the control portion may adjust a spraying direction of the spraying portion 320 according to a moving direction of the spraying portion 320 so as to improve application quality for side surfaces P1 and P2 of a protruding part P formed on the target surface SF.

FIG. 14A is a view illustrating a state in which application is performed by a conventional application apparatus in which a spraying direction of a spraying portion 320′ is not adjusted. Here, as shown in the drawing, paint is not normally sprayed onto the side surface P1 of the protruding part P such that it is difficult to expect securing of application quality.

However, in the present invention, as shown in FIGS. 14B and 14C, the above problem of the conventional application apparatus may be effectively solved by adjusting the spraying direction of the spraying portion 320 through the control portion.

When the spraying portion 320 sprays paint onto the target surface SF to be applied while moving along the target surface SF in the rightward direction D4 as shown in FIG. 14B, the control portion may control the spraying portion 320 to allow the spraying direction of the spraying portion 320 to be biased rightward.

In addition, when the spraying portion 320 sprays paint onto the target surface SF to be applied while moving along the target surface SF in the leftward direction D3 as shown in FIG. 14C, the control portion may control the spraying portion 320 to allow the spraying direction of the spraying portion 320 to be biased leftward.

When the spraying direction of paint by the spraying portion 320 has been biased rightward or leftward as described above, the paint is precisely applicable to the side surfaces P1 and P2 of the protruding part P so as to secure application quality.

Here, a degree of the spraying direction of the spraying portion 320 which is controlled by the control portion may vary according to a size, shape, and the like of the protruding part P and may vary on the basis of a spraying pressure of the paint by the spraying portion 320.

The application apparatus 100 according to the present invention may include a sensing portion (not shown) to obtain information on the protruding part P. The sensing portion may allow surface information of the target surface SF to be obtained while the first moving portion 110 moves from an uppermost line UP1 to a lowermost line LW1 of the target surface SF in the vertical direction D1-D2 so as to obtain information of the protruding part P.

The sensing portion may be an element which employs a mechanical contact method of obtaining information using a moving distance for coming into contact with the target surface SF, an optical method of obtaining information using a time or distance in which light emitted toward the target surface SF is reflected by the target surface SF and returns, or the like.

The control portion may adjust the degree of the spraying direction according to a moving direction of the spraying portion 320 on the basis of the surface information of the target surface SF obtained by the sensing portion while the first moving portion 110 moves in the vertical direction D1-D2.

Here, a plurality of such sensing portions may be formed on the first moving portion 110 so as to obtain surface information on the entirety of the target surface SF while the first moving portion 110 is moved from the uppermost line UP1 to the lowermost line LW1 of the target surface SF.

In other words, although the first moving portion 110 sequentially moves along the downward direction D2, the upward direction D1 and the downward direction D2 to apply paint to the first region R1, the second region R2, and the third region R3, the surface information of the entirety of the target surface SF may be obtained by the sensing portion while the first moving portion 110 moves along the downward direction D2 to apply the paint to the first region R1.

The surface information of the entirety of the target surface SF may be obtained by the sensing portion through the movement of the first moving portion 110 in the vertical direction D1-D2 regardless of application.

Also, the sensing portion may be mounted on the frame 330, may be moved in connection with the spraying portion 320, or may be moved on an upstream side of the spraying portion 320 in advance of movement of the spraying portion 320.

As described above, the control portion may control the spraying portion 320, on the basis of the surface information of the target surface SF obtained by the sensing portion, to allow the spraying direction to be biased in a particular direction according to a moving direction when the spraying portion 320 passes an area in which the protruding part P is present and may control the spraying portion to allow the spraying direction to be perpendicular as before when the spraying portion passes an area in which the protruding part P is not present.

However, while assuming the presence of the protruding part P on the target surface SF, the control portion may control the spraying direction of the spraying portion 320 to be biased leftward when the spraying portion 320 moves along the target surface in the leftward direction D3 and may control the spraying direction of the spraying portion 320 to be biased rightward when the spraying portion moves in the rightward direction D4.

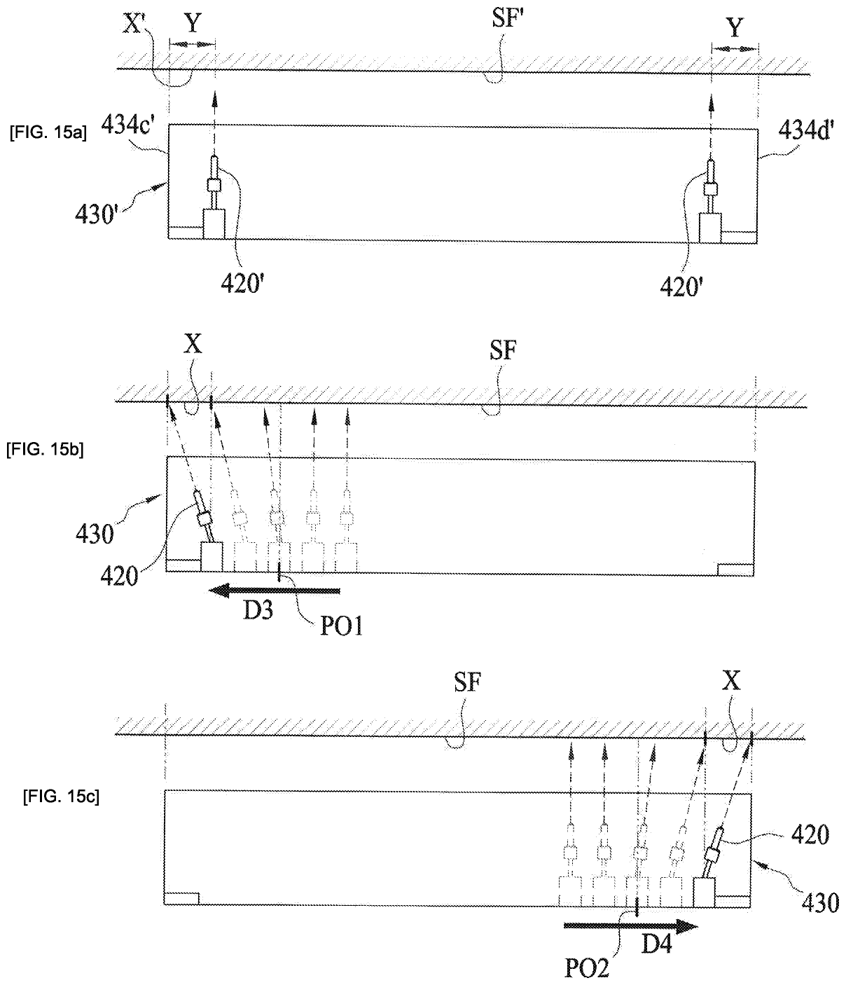

FIG. 15 is a view illustrating a second control method of a spraying portion provided in an application apparatus according to the present invention.

First, it should be noted that a second control method of a spraying portion 420 is applicable not only to the above-described embodiments but also all application apparatuses in which the spraying portion 420 sprays paint while moving in the lateral direction D3-D4.

Referring to FIG. 15, the spraying portion 420 may be mounted on the frame 430, which is equivalent to the second moving portion 130 described above with reference to FIGS. 1 to 10, to be movable on the frame 130 in the lateral direction D3-D4, and a spraying direction thereof may be controlled by a control portion.

The control portion is one element of the application apparatus according to the present invention and may control the overall application operation such as a spraying pressure and a spraying direction of paint sprayed by the spraying portion 420.

When the spraying portion 420 moves along the target surface SF in the lateral direction D3-D4 and sprays paint onto the target surface SF to be applied, the control portion may adjust the spraying direction of the spraying portion 420 to apply the paint even to a region X beyond a range in which the spraying portion 420 is movable in the lateral direction D3-D4.

FIG. 15A is a view illustrating a situation in which application is performed by a conventional application apparatus in which a spraying direction of a spraying portion is not adjusted. As shown in the drawing, a spraying portion 420′ is not movable as much as a distance equal to a width of a frame 430′ in the lateral direction D3-D4.

This is caused by structural characteristics of the spraying portion 420′ and a left cover frame 434c′, a right cover frame 434d′, and a lateral support frame which are included in the frame 430′. As shown in FIG. 15A, when the spraying portion 430′ is located at a left end of the lateral support frame, a certain distance Y is present between the spraying portion 420′ and the left cover frame 434′.

Also, even when the spraying portion 420′ is located at a right end of the lateral support frame, the certain distance Y is present between the spraying portion 420′ and the right cover frame 434d′.

Since the above distance Y causes a problem in which paint is not sprayed onto a particular area X′ of a target surface SF′ even when the spraying portion 420 is located at the left end of the lateral support frame or the right end of the lateral support frame, application quality is degraded.

However, in the present invention, as shown in FIGS. 15B and 15C, the above problem of the conventional application apparatus may be effectively solved by adjusting the spraying direction of the spraying portion 420 through the control portion.

When the spraying portion 420 moves along the target surface SF in the leftward direction D3 and sprays paint as shown in FIG. 15B, the control portion may control the spraying portion 420 to allow a spraying direction to be biased leftward at a predetermined first point PO1 from the left end on which the spraying portion is movable on the frame 430.

The control portion may increase a degree at which the spraying portion 420 is biased leftward while passing the predetermined first point PO1, and the predetermined first point PO1 may be determined on the basis of at least one of a spraying pressure and a spraying range of the spraying portion 420 with respect to the paint.

For example, the predetermined first point PO1 may be a point gradually closer to the left end on which the spraying portion 420 is movable on the frame 430 as the spraying pressure increases and the spraying range increases.

Also, the control portion may gradually decrease the degree of the spraying portion 420 being biased leftward from the predetermined first point PO1 as the spraying pressure increases and the spraying range increases.

When the spraying portion 420 moves along the target surface SF in the rightward direction D4 and sprays paint as shown in FIG. 15C, the control portion may control the spraying portion 420 to allow a spraying direction to be biased rightward at a predetermined second point P02 from the right end on which the spraying portion is movable on the frame 430.

The control portion may increase a degree at which the spraying portion 420 is biased rightward while passing the predetermined second point P02, and the predetermined second point P02 may be determined on the basis of at least one of a spraying pressure and a spraying range of the spraying portion 420 with respect to the paint.

For example, the predetermined second point P02 may be a point gradually closer to the right end on which the spraying portion 420 is movable on the frame 430 as the spraying pressure increases and the spraying range increases.

Also, the control portion may gradually decrease the degree of the spraying portion 420 being biased rightward from the predetermined second point P02 as the spraying pressure increases and the spraying range increases.

As described above, when the spraying direction of the spraying portion 420 with respect to paint changes at the predetermined first point PO1 and the predetermined second point P02, the paint may be sprayed even to the particular region X onto which the paint is not sprayed conventionally so as to realize an improvement in application quality.

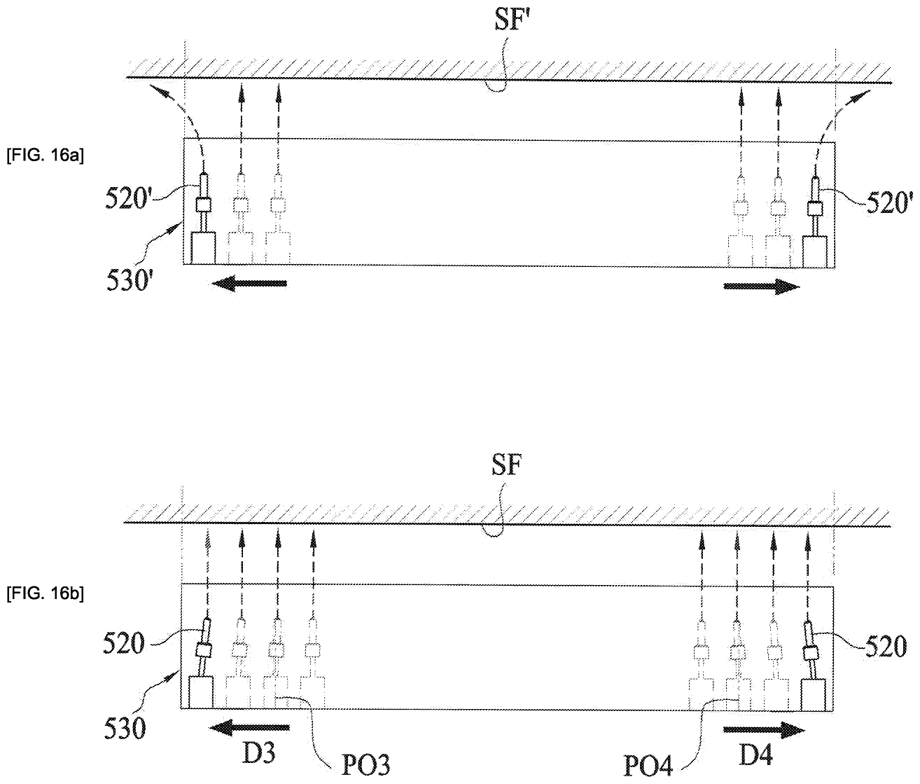

FIG. 16 is a view illustrating a third control method of a spraying portion provided in an application apparatus according to the present invention.

Referring to FIG. 16, a spraying portion 520 may be mounted on a frame 530, which is equivalent to the second moving portion 130 described above with reference to FIGS. 1 to 10, to be movable on the frame 530 in the lateral direction D3-D4, and a spraying direction thereof may be controlled by the control portion.

The control portion is one element of the application apparatus according to the present invention and may control the overall application operation such as a spraying pressure and a spraying direction of paint sprayed by the spraying portion 520.

When the spraying portion 520 moves along the target surface SF in the lateral direction D3-D4 and sprays the paint onto the target surface SF to be applied, the control portion may adjust the spraying direction of the spraying portion 520 to prevent the paint from scattering due to inertia generated as the spraying portion 520 arrives at the left end or the right end on which the spraying portion 520 is movable on the frame.

FIG. 16A is a view illustrating a situation in which application is performed by a conventional application apparatus in which a spraying direction of a spraying portion is not adjusted. As shown in the drawing, when a spraying portion 520′ arrives at a left end on which the spraying portion is movable on a frame 530′, paint scatters outward from a left side due to inertia of the spraying portion 520′ to move leftward.

Also, when the spraying portion 520′ arrives at a right end on which the spraying portion is movable on the frame, paint scatters outward from a right side due to inertia of the spraying portion 520′ to move rightward.

The scattering causes a lot of problems such as degradation of application quality and the like.

However, in the present invention, as shown in FIG. 16B, the above problem of the conventional application apparatus may be effectively solved by adjusting the spraying direction through the control portion.

When the spraying portion 520 moves along the target surface SF in the leftward direction D3 and sprays paint as shown in FIG. 16B, the control portion may control the spraying portion 520 to allow a spraying direction to be biased rightward at a predetermined third point P03 from the left end on which the spraying portion is movable on the frame 530.

The control portion may increase a degree at which the spraying portion 520 is biased rightward while passing the predetermined third point P03, and the predetermined third point P03 may be determined on the basis of at least one of a spraying pressure and a spraying range of the spraying portion 520 with respect to the paint.

For example, the predetermined third point P03 may be a point gradually closer to the left end on which the spraying portion 520 is movable on the frame 530 as the spraying pressure increases and the spraying range increases.

Also, the control portion may gradually decrease the degree of the spraying portion 520 being biased rightward from the predetermined third point P03 as the spraying pressure increases and the spraying range increases.

Also, when the spraying portion 520 moves along the target surface SF in the rightward direction D4 and sprays paint, the spraying portion 520 may be controlled to allow a spraying direction to be biased leftward at a predetermined fourth point P04 from the right end on which the spraying portion is movable on the frame 530.

The control portion may increase a degree at which the spraying portion 520 is biased leftward while passing the predetermined fourth point P04, and the predetermined fourth point P04 may be determined on the basis of at least one of a spraying pressure and a spraying range of the spraying portion 520 with respect to the paint.

For example, the predetermined fourth point P04 may be a point gradually closer to the right end on which the spraying portion 520 is movable on the frame 530 as the spraying pressure increases and the spraying range increases.

Also, the control portion may gradually decrease the degree of the spraying portion 520 being biased leftward from the predetermined fourth point P04 as the spraying pressure increases and the spraying range increases.

As described above, when the spraying direction of the spraying portion 520 with respect to paint changes at the predetermined third point P03 and the predetermined fourth point P04, the paint may be prevented from scattering due to inertia caused by movement of the spraying portion 520 so as to improve application quality and to solve a variety of problems which may be caused by scattering of the paint.

Although the components and features of the present invention have been described on the basis of the embodiments of the present invention, the present invention is limited thereto. Also, it is apparent to those skilled in the art that a variety of changes and modifications may be made without departing from the spirit and scope of the present invention. Therefore, it should be noted that the changes and modifications are included in the claims.

1. An application apparatus configured to apply paint to a target surface that is at least a part of a wall surface of a structure, comprising:
a first moving portion configured to be movable in a vertical direction according to a change in a length of a wire caused by driving of a winch drum; and
a spraying portion configured to be movable along the first moving portion in a leftward direction or a rightward direction and to directly spray paint onto the target surface or spray paint onto an application roller rolling in contact with the target surface so as to apply the paint to the target surface in a range of from a predetermined left line to a predetermined right line in the lateral direction,
wherein when the paint is sprayed while the first moving portion is located at a first position on the basis of a vertical direction, the spraying portion sprays the paint in a range from a predetermined left point corresponding to the first position to a predetermined right point corresponding to the first position while a uniform linear distance from the first moving portion according to a vertical direction is maintained,
wherein the first moving portion is movable in the vertical direction to allow the spraying portion to be movable from an uppermost line to a lowermost line of the target surface, and
wherein the first moving portion is moved only in any one of an upward direction and a lower direction so as to allow the paint sprayed by the spraying portion to be applied to a certain area within the range from the predetermined left line to the predetermined right line.

2. The application apparatus of claim 1, wherein the spraying portion moves in at least one direction of the leftward direction and the rightward direction and sprays the paint while the first moving portion is located at the first position.

3. The application apparatus of claim 2, wherein when the target surface is divided into a plurality of regions along the lateral direction on the basis of a moving range of the spraying portion in the lateral direction, the predetermined left line and the predetermined right line are an outermost left line and an outermost right line for a particular region, respectively.

4. The application apparatus of claim 1, wherein the first moving portion extends along the lateral direction of the target surface and covers a range of the target surface in the lateral direction.

5. The application apparatus of claim 1, wherein the first moving portion comprises a support portion provided to extend at a certain length along the lateral direction of the target surface and configured to support movement of the spraying portion and a rotating portion configured to rotate in contact with the target surface so as to move in the lateral direction while being spaced apart from the target surface.

6. The application apparatus of claim 1, further comprising a second moving portion mounted on the first moving portion and configured to support the spraying portion to allow the spraying portion to be movable along the first moving portion.

7. The application apparatus of claim 6, wherein the second moving portion defines a distance from the predetermined left point to the predetermined right point.

8. The application apparatus of claim 6, wherein when the applying of the paint to the certain area through movement of the first moving portion and spraying of the paint by the spraying portion is completed, the second moving portion is moved along the first moving portion to allow the paint sprayed by the spraying portion to be applied to another certain region within a range from another predetermined left line to another predetermined right line.

9. The application apparatus of claim 6, further comprising a first scattering prevention portion and a second scattering prevention portion which are disposed in front of the spraying portion and configured to prevent the paint sprayed through the spraying portion from scattering,
wherein the first scattering prevention portion prevents the paint sprayed through the spraying portion from scattering by absorbing the paint, and
wherein the second scattering prevention portion is disposed outside the first scattering prevention portion and expands a range of preventing the paint from scattering.

10. The application apparatus of claim 9, wherein the spraying portion moves in at least one direction of the leftward direction and the rightward direction and sprays the paint while the first moving portion is located at the first position,
wherein the first scattering prevention portion comprises a 1-1 scattering prevention portion and a 1-2 scattering prevention portion which are formed of cylindrical sponges and disposed on an upper front side and a lower front side of the spraying portion, respectively,
wherein the second moving portion comprises a lateral support frame configured to support movement of the spraying portion in the lateral direction and to define a moving range thereof in the lateral direction and a mounting frame on which the 1-1 scattering prevention portion and the 1-2 scattering prevention portion are rotatably mounted due to contact with the target surface,
wherein the mounting frame comprises an upper cover frame and a lower cover frame which are configured to cover an upper side and a lower side of the spraying portion, respectively,
wherein the 1-1 scattering prevention portion is disposed to be spaced apart from the upper cover frame so as to prevent interference with the upper cover frame when being rotated on the mounting frame due to the contact with the target surface, and
wherein the 1-2 scattering prevention portion is disposed to be spaced apart from the lower cover frame so as to prevent interference with the lower cover frame when being rotated on the mounting frame due to the contact with the target surface.

11. The application apparatus of claim 10, wherein the second scattering prevention portion comprises a 2-1 scattering prevention portion disposed above the 1-1 scattering prevention portion and configured to spray high-pressure air so as to prevent the paint sprayed from the spraying portion from scattering through a space between the 1-1 scattering prevention portion and the upper cover frame.

12. The application apparatus of claim 10, wherein the second scattering prevention portion comprises a 2-2 scattering prevention portion disposed below the 1-2 scattering prevention portion and configured to spray high-pressure air so as to prevent the paint sprayed from the spraying portion from scattering through a space between the 1-2 scattering prevention portion and the lower cover frame.

13. The application apparatus of claim 10, wherein the first scattering prevention portion is formed along the lateral direction to correspond to the moving range of the spraying portion in the lateral direction on the lateral support frame, and
wherein a plurality of such second scattering prevention portions are arranged and spaced apart along the lateral direction within the moving range of the spraying portion in the lateral direction.

14. The application apparatus of claim 10, wherein the first scattering prevention portion is disposed along the lateral direction to correspond to the moving range of the spraying portion in the lateral direction on the lateral support frame, and
wherein the second scattering prevention portion is disposed to be movable in the lateral direction in connection with the movement of the spraying portion in the lateral direction.

15. An application apparatus configured to apply paint to a target surface that is at least a part of a wall surface of a structure, comprising:
a first moving portion configured to be movable in a vertical direction from an uppermost line to a lowermost line of a target surface of the wall surface which needs an application of paint according to a change in a length of a wire caused by driving of a winch drum and formed to extend along a lateral direction of the target surface so as to cover a lateral range of the target surface; and
a spraying portion configured to be movable along the first moving portion in a leftward direction or a rightward direction and to directly spray paint onto the target surface or spray paint onto an application roller rolling in contact with the target surface so as to apply the paint to the target surface in a range of between a predetermined left line and a predetermined right line on the basis of a lateral direction,
wherein the spraying portion implements application of the paint in the vertical direction due to movement of the first moving portion in the vertical direction.
